(19) United States
(12) Patent Application Publication
(10) Pub. No.: US 2011/0250402 A1
(43) Pub. Date: Oct. 13, 2011

(54) LOCALIZATION OF NEAR-FIELD RESONANCES IN BOWTIE ANTENNAE: INFLUENCE OF ADHESION LAYERS

(75) Inventors: Mark Oldham, Emerald Hills, CA (US); Steven Blair, Salt Lake City, UT (US); Xiaojin Jiao, Salt Lake City, UT (US)

(73) Assignee: APPLIED BIOSYSTEMS, LLC, Carlsbad, CA (US)

(21) Appl. No.: 12/996,001

(22) PCT Filed: Jun. 2, 2009
(86) PCT No.: PCT/US2009/046027

§ 371 Date: Jun. 29, 2011

Related U.S. Application Data
(63) Continuation-in-part of application No. 12/284,109, filed on Sep. 18, 2008.
(60) Provisional application No. 61/130,811, filed on Jun. 2, 2008.

(51) Int. Cl. B32B 3/30; B32B 3/10; B82Y 99/00

(52) U.S. Cl. 428/172; 428/195.1; 428/209; 977/700

(57) ABSTRACT

A plasmonic nanostructure for enhanced light excitation is disclosed. The plasmonic nanostructure includes a substrate, an adhesion layer disposed on top of the substrate, a surface plasmon resonance layer, and a cavity that extends into the surface plasmon resonance layer. The surface plasmon resonance layer is configured to concentrate an applied plasmon field to a bottom portion of the cavity.

### RELATED APPLICATIONS

This application is the National Stage of International Application No. PCT/US2009/046027, filed Jun. 2, 2009 and published as International Publication No. WO 2009/149125 on Dec. 10, 2009, and claims priority to U.S. Provisional Application No. 61/130,811, filed on Jun. 2, 2008 all of which applications are hereby incorporated by reference in their entirety.

### TECHNICAL FIELD

The embodiments described herein relate to systems and apparatuses for light emission enhancement and detection and, more particularly, to plasmonic nanostructures and optical antennae structures for light emission enhancement.

### BACKGROUND

Considerable attention has been paid to plasmonic nanostructures for applications in nanophotonics and enhanced light emission. Optical antennae formed by coupled metallic nano-segments have become one of the kernel structures due to its large near-field enhancement and confinement, and high far-field radiative efficiency. The strong improvement of the matching of far-field optical radiation with near-field localization makes optical antennae extremely promising elements for extraction of light from emitters. That is, the near-field and far-field optical properties may render optical antennae more suitable for single molecule studies when compared against the zero-mode waveguide structure (one of the more promising structures for this type of application). Moreover, bowtie antennae, i.e. coupled triangles, may have stronger field confinement due to the efficient suppression of field enhancement at the outer ends of the structure.

Detailed information about near-field localization inside the enhancement regions of nanostructures is generally lacking, and particularly information with respect to the effects of adhesion layers. However, theory dictates that the effect of even thin adhesion layers can be quite significant, and that the effect can be quite different for different materials. It is desired for many applications (particularly for single molecule sequencing) that the observation volume be as small as possible, and that the field enhancement be confined to the volume nearest the substrate.

Accordingly, there is a need for plasmonic nanostructures that concentrate the field enhancement in the volume within the enhancement region nearest the surface of the substrate. One conventional approach to addressing this need involves the use of “zero mode waveguides” with circular polarization. Although, this approach succeeds in providing a high ratio between the E field at the bottom of the “zero mode waveguide”, there is almost no enhancement associated with the structure.

### SUMMARY

Systems and apparatuses for light emission enhancement and detection are disclosed.

In one aspect, a plasmonic nanostructure for enhanced light excitation is disclosed. The plasmonic nanostructure includes a substrate, an adhesion layer disposed on top of the substrate, a surface plasmon resonance layer, and a cavity that extends into the suface plasmon resonance layer. The surface plasmon resonance layer is configured to concentrate an applied plasmon field to a bottom portion of the cavity.

In another aspect, a different plasmonic nanostructure for enhanced light excitation is disclosed. The plasmonic nanostructure includes a substrate, an adhesion layer disposed on top of the substrate, and a bow-tie shaped surface plasmon resonance structure.

The bow-tie shaped surface plasmon resonance structure is comprised of a first oppositely-directed isosceles trapezoidal portion, a second oppositely directed isosceles trapezoidal portion, and a plasmon field enhancement region located in between the oppositely-directed isosceles trapezoidal portions, wherein the bow-tie shaped surface plasmon resonance structure is configured to concentrate an applied plasmon field to a bottom portion of the plasmon field enhancement region.

In still another aspect, a nanochannel for enhanced light excitation is disclosed. The nanochannel includes a substrate, an adhesion layer disposed on top of the substrate, a surface plasmon resonance layer disposed on top of the adhesion layer, and a nanochannel defined across a top surface of the surface plasmon resonance layer. The nanochannel is configured to concentrate an applied plasmon field to a bottom portion of the nanochannel.

These and other features, aspects, and embodiments are described below in the section entitled “Detailed Description.”

### BRIEF DESCRIPTION OF THE FIGURES

For a more complete understanding of the principles disclosed herein, and the advantages thereof, reference is now made to the following descriptions taken in conjunction with the accompanying drawings, in which:

FIG. 1 shows a top view of a bowtie plasmonic nanostructure, according to one embodiment.

FIG. 2A shows a cross sectional side view of a conventional bowtie plasmonic nanostructure.

FIG. 2B is a graph that depicts the average level of enhancement in different volumes in the gap of the conventional bowtie plasmonic nanostructure of FIG. 2A.

FIG. 3A shows a cross sectional side view of another conventional bowtie plasmonic nanostructure with an adhesion layer, wherein the adhesion layer is etched in the gap area between the two sections that comprise the conventional bowtie plasmonic nanostructure.

FIG. 3B is a graph that depicts the average level of enhancement in different volumes in the gap of the conventional bowtie plasmonic nanostructure of FIG. 3A.

FIG. 3C is a graph that depicts the average level of enhancement with different adhesion layer thicknesses in the gap of the conventional bowtie plasmonic nanostructure of FIG. 3A.

FIG. 3D is a graph that depicts the average level of enhancement with different adhesion layer materials in the gap of the conventional bowtie plasmonic nanostructure of FIG. 3A.

FIG. 4A shows a cross sectional side view of a bowtie plasmonic nanostructure, wherein the adhesion layer is not etched in the gap area between the two sections that comprise the bowtie plasmonic nanostructure, according to one embodiment.

FIG. 4B is a graph that depicts the average level of enhancement in different volumes in the gap of the bowtie plasmonic nanostructure of FIG. 4A.

FIG. 5A shows a cross sectional side view of a bowtie plasmonic nanostructure with an adhesion layer, wherein the adhesion layer is etched in the gap area between the two sections that comprise the bowtie, and a cover layer is adhered to the top of the bowtie plasmonic nanostructure, according to one embodiment.

FIG. 5B shows the average level of enhancement in different volumes in the gap of the bowtie structure of FIG. 5A.

FIG. 6 shows a cross sectional side view of a bowtie plasmonic nanostructure with adhesion layer, wherein the adhesion layer is not etched in the gap area between the two sections that comprise the bowtie, and the adhesion layer is comprised of the same material as the bowtie structure, according to one embodiment.

FIG. 7 shows a cross sectional side view of a bowtie plasmonic nanostructure with an adhesion layer, wherein the adhesion layer is not etched in the gap area between the two sections that comprise the bowtie and a cavity defined within the bowtie metal layer does not extend through to the adhesion layer, according to one embodiment.

FIG. 8A shows a cross sectional side view of a plasmonic nanostructure comprised of a cavity defined through a cover layer, a metal layer and an adhesion layer, according to one embodiment.

FIG. 8B shows a cross sectional side view of a plasmonic nanostructure comprised of a cavity defined through a cover layer and a metal layer, according to one embodiment.

FIG. 8C shows a cross sectional side view of a plasmonic nanostructure comprised of a cavity that extends through a cover layer and a metal layer, but not through to an adhesion layer, according to one embodiment.

FIG. 9A shows a top view of a plasmonic nanochannel structure, according to one embodiment.

FIG. 9B shows a top view of a plasmonic nanowell, according to one embodiment.

### DETAILED DESCRIPTION

The embodiments described herein may be understood more readily by reference to the following detailed description and the Examples included herein. It should be understood that the terminology used herein is for the purpose of describing specific embodiments only and is not intended to be limiting. Furthermore, in the following detailed description of the embodiments, numerous specific details are set forth in order to provide a thorough understanding of them.

Unless defined otherwise, all technical and scientific terms used herein have the same meaning as is commonly understood by one of ordinary skill in the art.

As used herein, “a” or “an” means “at least one” or “one or more.”

“Optional” or “optionally” means that the subsequently described event or circumstance may or may not occur, and that the description includes instances where the event occurs and instances where it does not.

As used herein, “about” means that the numerical value is approximate and small variations would not significantly affect the practice of the embodiments described herein and remain within the scope of the embodiments. Where a numerical limitation is used, unless indicated otherwise by the context, “about” means the numerical value can vary by ±10% and remain within the scope of the embodiments.

The following terms are used to describe the various embodiments detailed below.

Plasmon resonance can be defined as a collective oscillation of free electrons or plasmons at optical frequencies.

Surface plasmons can be those plasmons that are confined to surfaces and that interact strongly with light resulting in a polariton. They can occur at the interface of a material with a positive dielectric contact with that of a negative dielectric constant (usually a metal or doped dielectric).

Resonant structure can refer to a structure such as a nano-antenna or nano-particles that use plasmon resonance along with shape of the structure to concentrate light energy to create a small zone of high local electric field.

Fluorescence enhancement ratio (FER) can refer to a ratio of the fluorescence photons collected from the excitation zone associated with a resonant structure element relative to the photons that would be collected from an equivalent sized zone with no resonant structure element and with all other variables held constant.

Enhancement or enhancement ratio is meant to define the ratio between the incident excitation E field and the E field in a volume associated with a nanostructure.

One of ordinary skill in the art would readily recognize that the principles described herein with respect to the various exemplary embodiments are applicable to, and can be implemented in all types of detection systems including, but not limited to: biomolecule detection, hybridization, DNA sequencing, FCS, single molecule, molecular complex, or bulk kinetic studies. etc.; and that any such variations do not depart from the true spirit and scope of the embodiments described herein. Detection methods can include the detection of fluorescence, FRET, scattering, quantum dots, upconverting phosphors, etc. Moreover, in the following detailed description, references are made to the accompanying figures, which illustrate specific embodiments. Electrical, mechanical, logical and structural changes may be made to the embodiments without departing from the spirit and scope of the embodiments described herein.

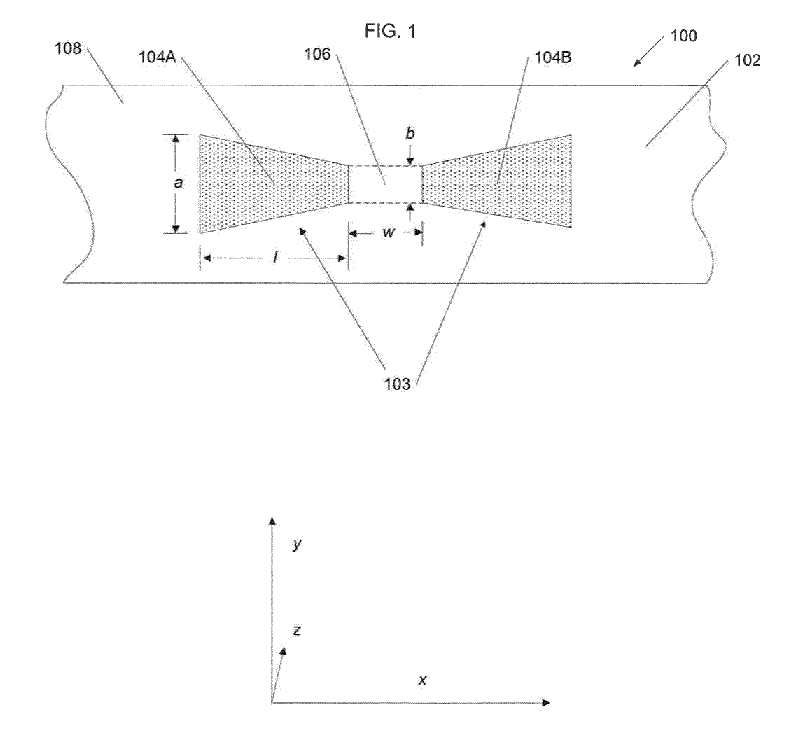

FIG. 1 shows a top view of a bowtie plasmonic enhancement nanostructure, according to one embodiment. As shown herein, the bowtie plasmonic enhancement nanostructure 100 can be comprised of a bow-tie shaped surface plasmon resonance structure 103 that resides on a substrate 102. The substrate 102 can be comprised of any appropriate dielectric material, including, but not limited to: fused silica, quartz, optical glasses such as BK7, SiO₂, silica, amorphous silicon, silicon nitride, etc.

The bow-tie shaped surface plasmon resonance structure 103 can be comprised of oppositely-directed portions (104a and 104b) that are separated by a gap region 106 (i.e., plasmon field enhancement region). As depicted, the oppositely-directed portions (104a and 104b) of the bow-tie shaped surface plasmon resonance structure 103 essentially form a dipole antennae structure. However, it should be appreciated that the bow-tie shaped surface plasmon resonance structure 103 can also take other forms or configurations including, but not limited to, a monopole or an enclosed bowtie. In one embodiment, the oppositely-directed portions (104a and 104b) have a trapezoidal shape. In another embodiment, the oppositely-directed portions (104a and 104b) have a rectangular shape. It should be appreciated, however, that the oppositely-directed portions (104a and 104b) can take any shape as long as the resulting plasmon resonance structure 103 can effectuate plasmonic enhancement at gap region 106.

The bow-tie shaped surface plasmon resonance structure 103 can be comprised of various metallic materials. For example, in one embodiment, the bow-tie shaped surface plasmon resonance structure 103 is comprised of gold (Au). In another embodiment, the bow-tie shaped surface plasmon resonance structure 103 is comprised of silver (Ag). In still another embodiment, the bow-tie shaped surface plasmon resonance structure 103 is comprised of aluminum (Al). In still yet another embodiment, the bow-tie shaped surface plasmon resonance structure 103 is comprised of a metal alloy. It should be understood that the bow-tie shaped surface plasmon resonance structure 103 can be comprised of essentially any metallic material that can concentrate a plasmonic field in gap region 106, including any of the coinage metals.

As shown in FIG. 1, the surface of the substrate 102 can also optionally be covered by an adhesion layer 108 (which can function to prevent loss of adhesion between the substrate 102 and the bow-tie shaped surface plasmon resonance structure 103). The optional adhesion layer can be comprised of many different types of adhesion material including, but not limited to, a chromium-based material (Cr, Cr₂O₃, etc.), a titanium-based material (e.g., Ti, TiO₂, etc.), Al, Al₂O₃, Ta, Cu, Pb, amorphous Si, GaAs, other semiconducting materials, Chalcogenide glasses (which may also be amorphous, metal doped, or rare earth metal doped), and indium tin oxide (ITO).

The dimensions of plasmonic nanostructure 100 can vary depending on the type of metal used (for the bow-tie shaped surface plasmon structure 103), the desired excitation wavelength, the desired emission wavelength, the desired size of the enhancement region 106, the desired level of enhancement in the enhancement region 106, and the amount of enhancement in the volumes that are not located within enhancement region 106. For example, the length (l) of the oppositely-directed portions (104a and 104b) will increase with increasing wavelength of excitation, and the level of enhancement will increase with decreasing width (w) of the gap region (enhancement region) 106 between the oppositely-directed portions (104a and 104b) of the bow-tie shaped surface plasmon structure 103. For example, the resonant wavelength can be set to about 630 nm by choosing appropriate parameters for the bow-tie shaped surface plasmon structure 103 (metal=Au, the widths of two ends of arms, a=80 nm, b=30 nm, the length of each of the oppositely-directed portions (104a and 104b), l=72 nm, the width of gap region 106, g=60˜nm, and the thickness of the bow-tie shaped surface plasmon structure 103, t=50 nm).

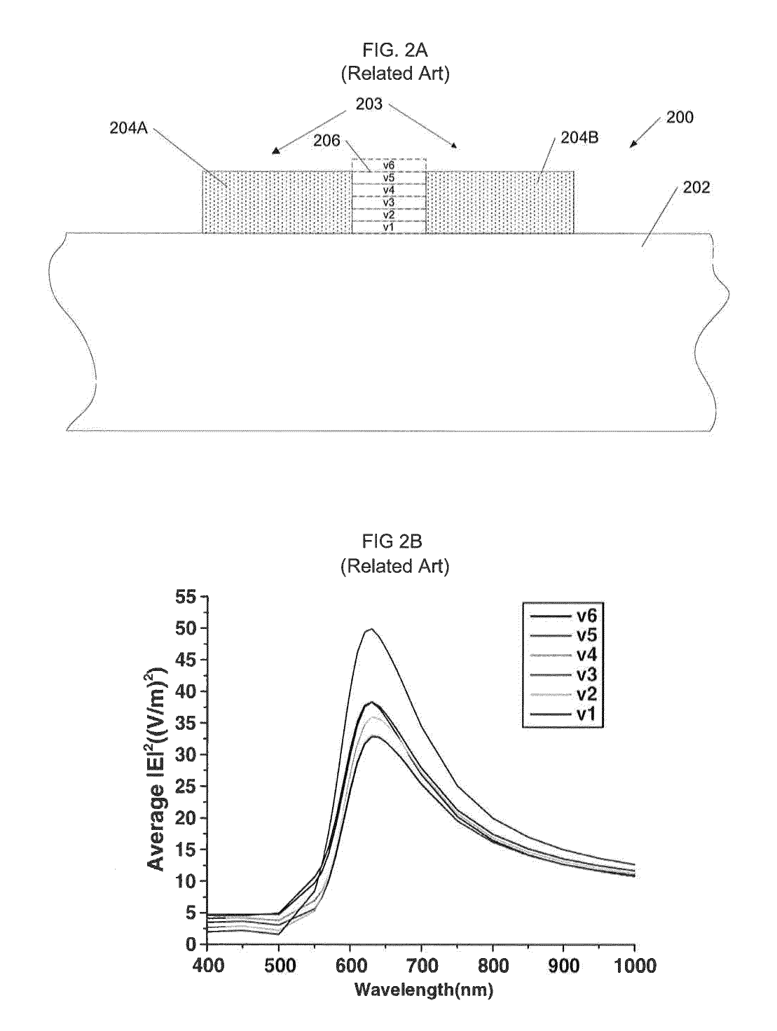

FIG. 2A shows a cross sectional side view of a conventional bowtie plasmonic enhancement nanostructure. As shown herein, the conventional bowtie plasmonic enhancement nanostructure 200 is comprised of a bow-tie shaped surface plasmon resonance structure 203 that resides on a surface of a substrate 202. The substrate 202 can be comprised of any appropriate dielectric material, such as fused silica, quartz, optical glasses such as BK7, SiO₂, silica, amorphous silicon, silicon nitride, etc.

The bow-tie shaped surface plasmon resonance structure 203 is comprised of oppositely-directed portions (204a and 204b) that are separated by a gap region 206 (i.e., plasmon field enhancement region). As depicted, the oppositely-directed portions (204a and 204b) of the bow-tie shaped surface plasmon resonance structure 203 essentially form a dipole antennae structure. In general, conventional bow-tie shaped surface plasmon resonance structure 203 is comprised of gold (Au). The most distinguishing feature of this conventional nanostructure 200 is the lack of an adhesion layer between the substrate 202 and the plasmon resonance structure 203. This is perhaps representative of the overly simplistic conventional thinking that neglected the importance of the adhesion layer in directing the level of plasmon enhancement at the various volumes (i.e., v1 to v6) within the gap region 206.

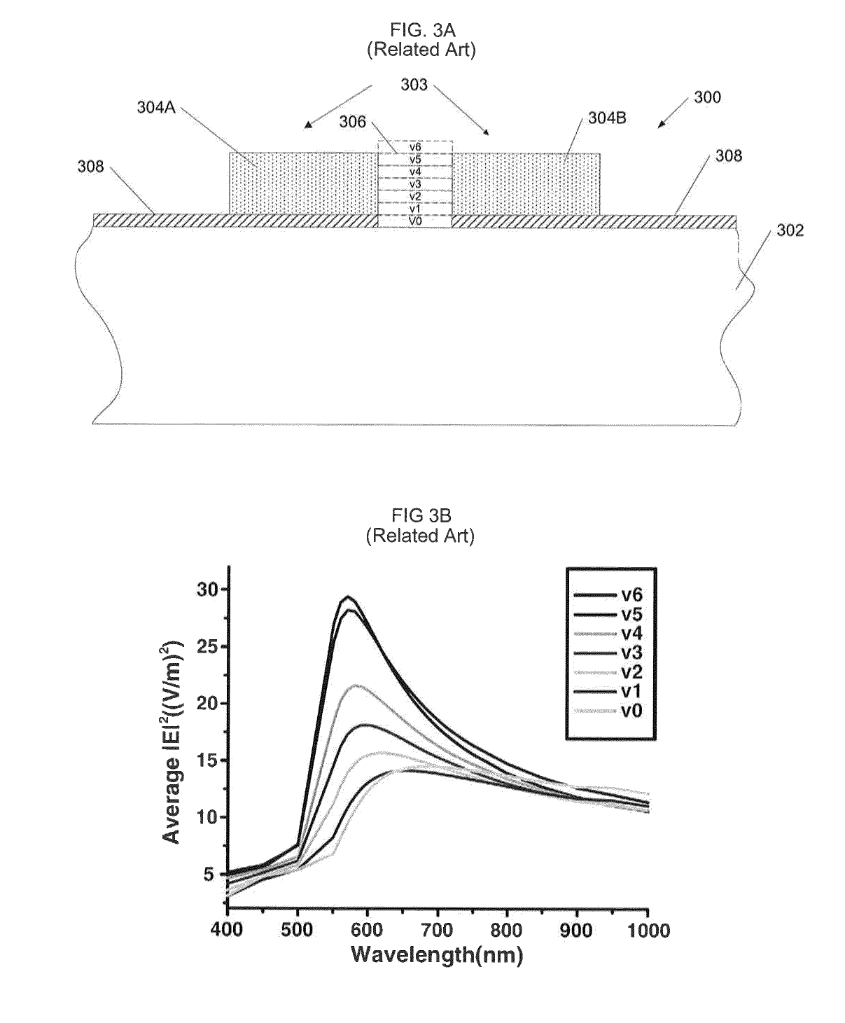

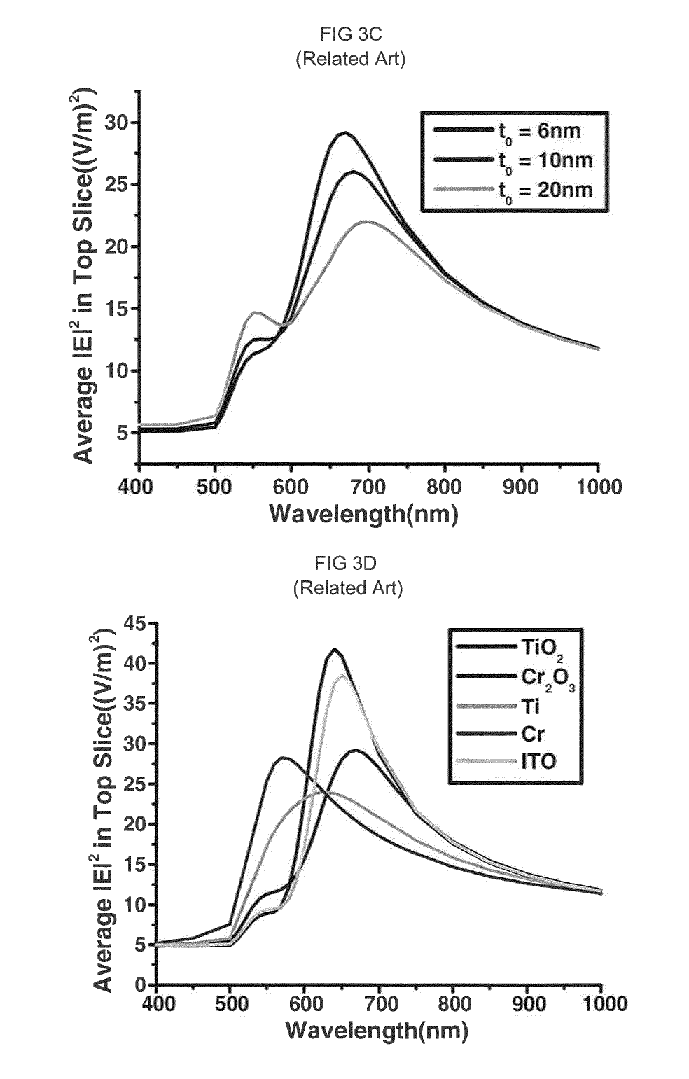

FIG. 3A shows a cross sectional side view of another conventional bowtie plasmonic enhancement nanostructure with an adhesion layer, wherein the adhesion layer is etched in the gap area between the two sections that comprise the bowtie plasmonic nanostructure. As shown herein, the conventional bowtie plasmonic enhancement nanostructure 300 is comprised of a bow-tie shaped surface plasmon resonance structure 303 that resides on an adhesion layer 302, which lies on the surface of a substrate 302. The substrate 302 can be comprised of any appropriate dielectric material, such as fused silica, quartz, optical glasses such as BK7, SiO₂, silica, amorphous silicon, silicon nitride, etc.

The bow-tie shaped surface plasmon resonance structure 303 can be comprised of oppositely-directed portions (304a and 304b) that are separated by a gap region 306 (i.e., plasmon field enhancement region). As depicted, the oppositely-directed portions (304a and 304b) of the bow-tie shaped surface plasmon resonance structure 303 essentially form a dipole antennae structure. In general, conventional bow-tie shaped surface plasmon resonance structure 303 is comprised of gold (Au).

As shown in FIG. 3A, the surface of the substrate 302 is covered by an adhesion layer 308 (which can function to prevent loss of adhesion between the substrate 302 and the bow-tie shaped surface plasmon resonance structure 303). In this conventional configuration, the adhesion layer 308 is typically comprised of either a chromium-based material (Cr, Cr₂O₃, etc.) or indium tin oxide (ITO). As shown in FIG. 3A, the adhesion is etched or masked in the enhancement region 306.

The enhancement region 306 is the volume in the nanostructure 300 where plasmon enhancement is desired, and is depicted here as consisting of several volumes (v0 to v6). v1-v5 represent volumes each with about a 10 nm thickness covering the enhancement region 306 (the combined thickness of v1-v5 should approximate the thickness of the bow-tie shaped surface plasmon resonance structure 303), while v0 represents a volume within the masked or etched portion of the adhesion layer 308 (and have a thickness that should be approximate the thickness of the adhesion layer 308), and v6 represents a volume with 6 nm thickness covering top region above the gap.

Through analysis of the magnitude and phase in enhancement region 306 it is apparent that Eₓ is symmetric and E_{z} is antisymmetric about the z axis, which is also consistent with the characteristics of the longitudinal component of gap surface plasmon polaritons (G-SPPs) in the metal insulator metal (MIM) structure. G-SPPs can be excited inside the gap region by the near-field coupling of the short range surface plasmon polaritons (SR-SPP) mode at the corners, which makes Eₓ dominant inside the gap. The similar scale of the gap region (60×30×50 nm) to that of trapezoidal segment (˜72×50×50 nm) increases the weight of the field pattern related to the G-SPP mode. The excitation of the G-SPP alters the phase change of SR-SPP mode reflection at the interfaces of the gap region. Change of the gap size alters the resonant condition of the structure, which explains why the change of gap size shifts the resonant wavelength of the bowtie antenna. Here, the G-SPP is deemed to couple the SR-SPP modes of the two trapezoidal segments.

Based on simulation of this structure, the field localizes on the top and bottom region in the gap of bowtie antenna due to the dominant status of SR-SPPs in the structure resonance. The G-SPP also exists inside the gap region, which plays the role of coupling between the two segments.

In certain embodiments, it may be desirable to minimize the enhancement nearest the substrate 302 (at the bottom) of enhancement region 306, which can result from utilization of an adhesion layer 308 that is of an appropriate material, such as Cr, and is not etched or masked at the bottom of the enhancement region 306.

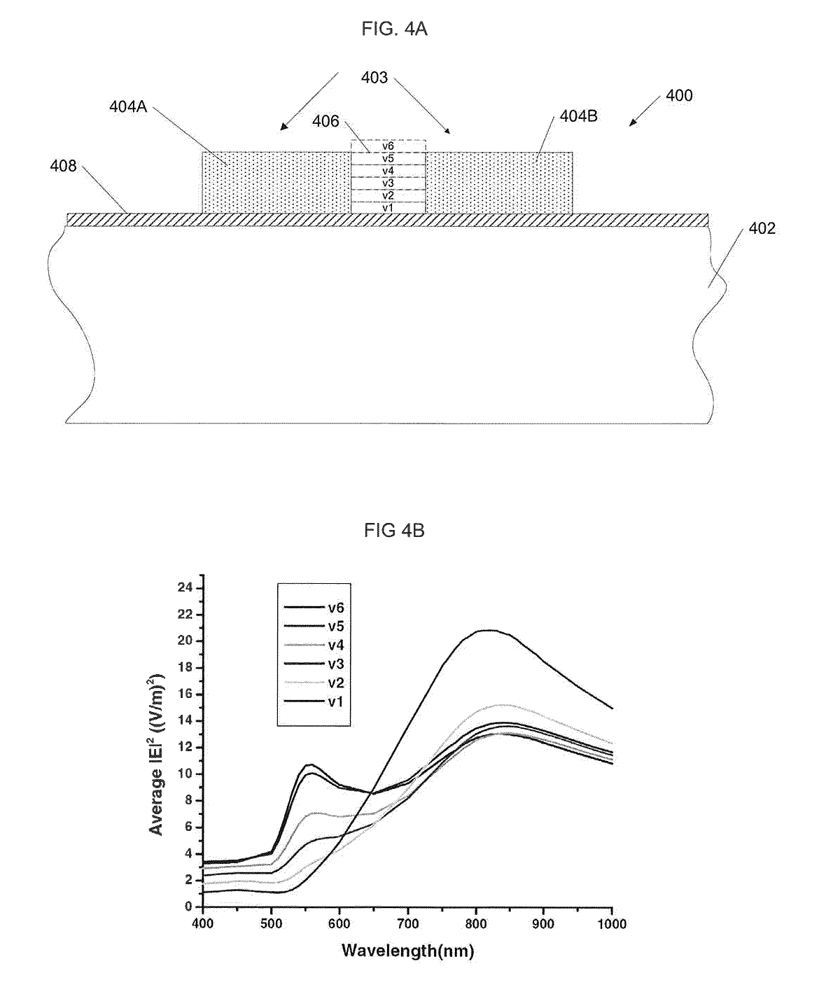

FIG. 4A shows a cross sectional side view of a bowtie plasmonic enhancement nanostructure with an adhesion layer, wherein the adhesion layer is not etched in the gap area between the two sections that comprise the bowtie plasmonic nanostructure, according to one embodiment. As shown herein, the bowtie plasmonic enhancement nanostructure 400 can be comprised of a bow-tie shaped surface plasmon resonance structure 403 that resides on an adhesion layer 402, which lies on the surface of a substrate 402. The substrate 402 can be comprised of any appropriate dielectric material, such as fused silica, quartz, optical glasses such as BK7, SiO₂, silica, amorphous silicon, silicon nitride, etc.

The bow-tie shaped surface plasmon resonance structure 403 can be comprised of oppositely-directed portions (404a and 404b) that are separated by a gap region 406 (i.e., plasmon field enhancement region). As depicted, the oppositely-directed portions of the bow-tie shaped surface plasmon resonance structure 403 essentially form a dipole antennae structure. However, it should be appreciated that the bow-tie shaped surface plasmon resonance structure 403 can also take other forms or configurations including, but not limited to, a monopole or an enclosed bowtie. In one embodiment, the oppositely-directed portions (404a and 404b) have a trapezoidal shape. In another embodiment, the oppositely-directed portions (404a and 404b) have a rectangular shape. It should be appreciated, however, that the oppositely-directed portions (404a and 404b) can take any shape as long as the resulting nanostructure 400 can effectuate plasmonic enhancement at gap region 406.

The bow-tie shaped surface plasmon resonance structure 403 can be comprised of various metallic materials. For example, in one embodiment, the bow-tie shaped surface plasmon resonance structure 403 is comprised of gold (Au). In another embodiment, the bow-tie shaped surface plasmon resonance structure 403 is comprised of silver (Ag). In still another embodiment, the bow-tie shaped surface plasmon resonance structure 403 is comprised of aluminum (Al). In still yet another embodiment, the bow-tie shaped surface plasmon resonance structure 403 is comprised of a metal alloy. It should be understood, however, that the bow-tie shaped surface plasmon resonance structure 403 can be comprised of any metallic material that can concentrate a plasmonic field in gap region 406, including any of the coinage metals.

As shown in FIG. 4A, the surface of the substrate 402 can be covered by an adhesion layer 408 (which can function to prevent loss of adhesion between the substrate 402 and the bow-tie shaped surface plasmon resonance structure 403). The adhesion layer 408 can be comprised of many different types of adhesion material including, but not limited to, a chromium-based material (Cr, Cr₂O₃, etc.), a titanium-based material (e.g., Ti, TiO₂, etc.), Al, Al₂O₃, Ta, Cu, Pb, amorphous Si, GaAs, other semiconducting materials, Chalcogenide glasses (which may also be amorphous, metal doped, or rare earth metal doped), and indium tin oxide (ITO).

As shown in FIG. 4A, the adhesion layer 408 is intact in the enhancement region 406.

The dimensions of plasmonic nanostructure 400 can vary depending on the type of metal used (for the bow-tie shaped surface plasmon structure 403), the desired excitation wavelength, the desired emission wavelength, the desired size of the enhancement region 406, the desired level of enhancement in the enhancement region 406, and the amount of enhancement in the volumes that are not located within enhancement region 406.

Enhancement region 406 can be the volume in the nanostructure where enhancement is desired, and is depicted here as consisting of several volumes (v1 to v6). v1-v5 can represent volumes each with about a 10 nm thickness covering the enhancement region 406 (the combined thickness of v1-v5 should approximate the thickness of the bow-tie shaped surface plasmon resonance structure 403), while v6 can represent a volume with about 6 nm thickness covering a top region above the gap.

In certain embodiments, it may be desirable to minimize the enhancement nearest the substrate 402 (at the bottom) of enhancement region 406, which can result from utilization of an adhesion layer 408 that is of an appropriate material, such as Cr, and is not etched or masked at the bottom of the enhancement region 406.

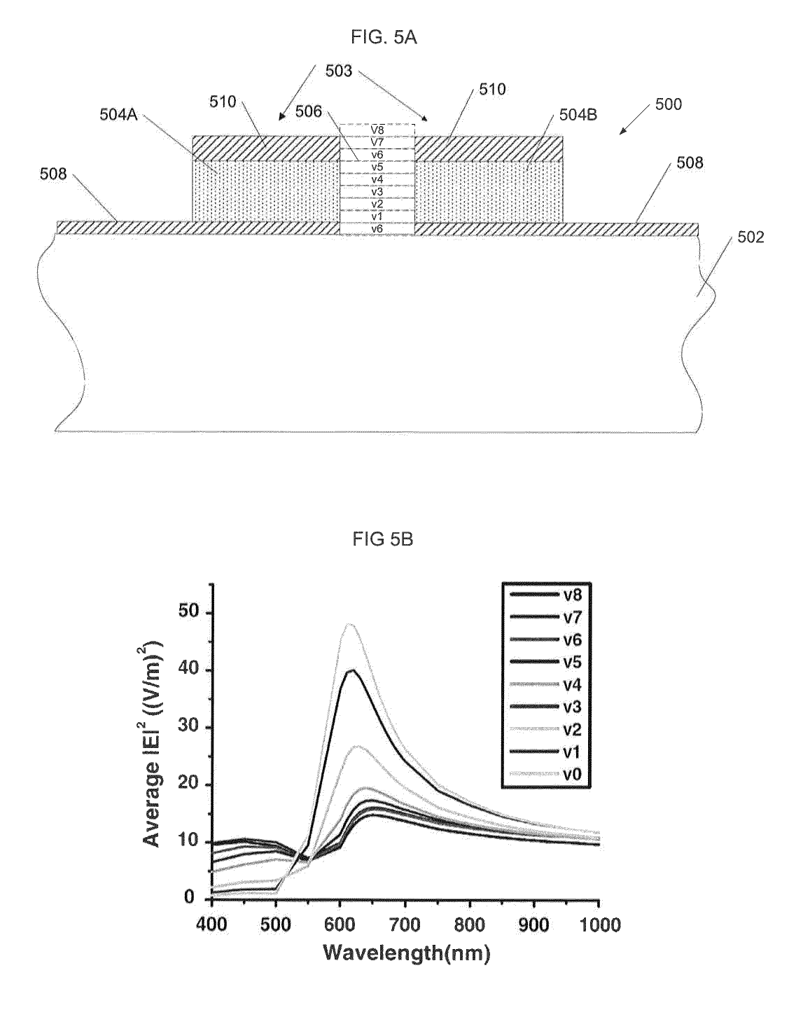

FIG. 5A shows a cross sectional side view of a bowtie plasmonic enhancement nanostructure with an adhesion layer, wherein the adhesion layer can be etched in the gap area between the two sections that comprise the bowtie, and a cover layer is adhered to the top of the bowtie plasmonic nanostructure, according to one embodiment. As shown herein, the bowtie plasmonic enhancement nanostructure 500 can be comprised of a bow-tie shaped surface plasmon resonance structure 503 that resides on an adhesion layer 508, which lies on the surface of a substrate 502. The substrate 502 can be comprised of any appropriate dielectric material, such as fused silica, quartz, optical glasses such as BK7, SiO₂, silica, amorphous silicon, silicon nitride, etc.

The bow-tie shaped surface plasmon resonance structure 503 can be comprised of oppositely-directed portions (504a and 504b) that are separated by a gap region 506 (i.e., plasmon field enhancement region). As depicted, the oppositely-directed portions (504a and 504b) of the bow-tie shaped surface plasmon resonance structure 503 essentially form a dipole antennae structure. However, it should be appreciated that the bow-tie shaped surface plasmon resonance structure 503 can also take other forms or configurations including, but not limited to, a monopole or an enclosed bowtie. In one embodiment, the oppositely-directed portions (504a and 504b) have a trapezoidal shape. In another embodiment, the oppositely-directed portions (504a and 504b) have a rectangular shape. It should be appreciated, however, that the oppositely-directed portions (504a and 504b) can take any shape as long as the resulting nanostructure can effectuate plasmonic enhancement at gap region 506.

The bow-tie shaped surface plasmon resonance structure 503 can be comprised of various metallic materials. For example, in one embodiment, the bow-tie shaped surface plasmon resonance structure 503 is comprised of gold (Au). In another embodiment, the bow-tie shaped surface plasmon resonance structure 503 is comprised of silver (Ag). In still another embodiment, the bow-tie shaped surface plasmon resonance structure 503 is comprised of aluminum (Al). In still yet another embodiment, the bow-tie shaped surface plasmon resonance structure 503 is comprised of a metal alloy. It should be understood, however, that the bow-tie shaped surface plasmon resonance structure 103 can be comprised of any metallic material that can concentrate a plasmonic field in gap region 106, including any of the coinage metals.

As shown in FIG. 5A, the surface of the substrate 502 can be covered by an adhesion layer 508 (which can function to prevent loss of adhesion between the substrate 102 and the bow-tie shaped surface plasmon resonance structure 503). The adhesion layer 508 can be comprised of many different types of adhesion material including, but not limited to, a chromium-based material (Cr, Cr₂O₃, etc.), a titanium-based material (e.g., Ti, TiO₂, etc.), Al, Al₂O₃, Ta, Cu, Pb, amorphous Si, GaAs, other semiconducting materials, Chalcogenide glasses (which may also be amorphous, metal doped, or rare earth metal doped), and indium tin oxide (ITO).

As depicted, a cover layer 510 is adhered to the top of the bowtie plasmonic resonance structure 503. In general, the cover layer 510 can be made of any materials which can adhere to plasmon resonance structure 503, and can be of materials similar to those used for the adhesion layer 508 such as Cr, Cr₂O₃, a titanium-based material (e.g., Ti, TiO₂, etc.), Al, Al₂O₃, Ta, Cu, Pb, amorphous Si, GaAs, other semiconducting materials, Chalcogenide glasses (which may also be amorphous, metal doped, or rare earth metal doped), and indium tin oxide (ITO).

In one embodiment, cover layer 510 is configured to cause higher levels of enhancement in the volume closest to the substrate (bottom) relative to the volume farthest from the substrate (top) in the enhancement region 506. In another embodiment, cover layer 510 is configured to cause lower levels of enhancement in the volume closest to the substrate (bottom) relative to the volume farthest from the substrate 502 (top) in the enhancement region 506. In still another embodiment, cover layer 510 can be configured to cause similar levels of enhancement in the volume closest to the substrate 502 (bottom) relative to the volume farthest from the substrate 502 (top) in the enhancement region 506.

In certain embodiments, it may be desirable to maximize the enhancement nearest the substrate 500 (at the bottom) of enhancement region 506, which can result from masking or etching through adhesion layer 508, combined with an appropriate choice of material for adhesion layer 508, such as ITO.

The dimensions of plasmonic nanostructure 500 can vary depending on the type of metal used (for the bow-tie shaped surface plasmon structure 503), the desired excitation wavelength, the desired emission wavelength, the desired size of the enhancement region 506, the desired level of enhancement in the enhancement region 506, and the amount of enhancement in the volumes that are not located within enhancement region 506.

Enhancement region 506 can be the volume in the nanostructure where enhancement is desired, and is depicted herein as consisting of several volumes (v0 to v8). v1-v5 can represent volumes that are about 10 nm thick covering the enhancement region 506 (the combined thickness of v1-v5 should approximate the thickness of the bow-tie shaped surface plasmon resonance structure 503), while v0 can represent a volume within the masked or etched portion of the adhesion layer 508, v6-v7 can represent volumes in the etched portion of the cover layer 510, and v8 can represent a volume that is about 6 nm thick covering top region above the gap.

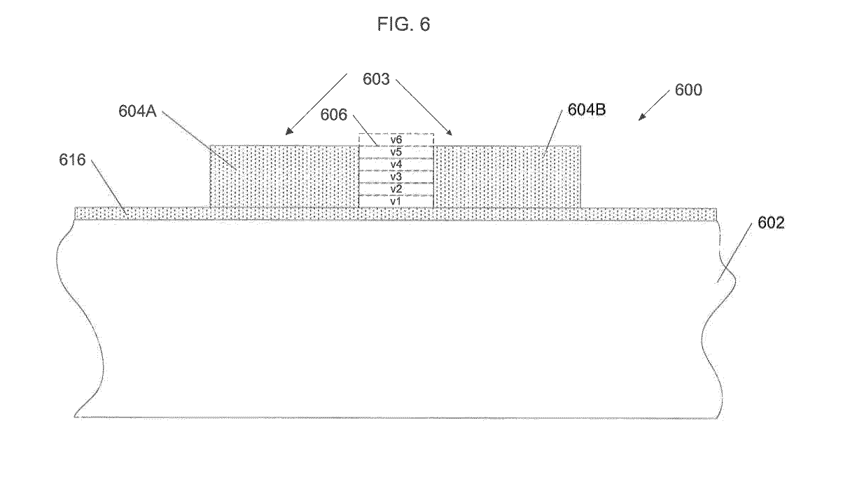

FIG. 6 shows a cross sectional side view of a bowtie plasmonic nanostructure with an adhesion layer, wherein the adhesion layer is not etched in the gap area between the two sections that comprise the bowtie surface plasmon resonance structure, and the adhesion layer can be comprised of the same material as the bowtie plasmonic enhancement nanostructure, according to one embodiment. As shown herein, the bowtie plasmonic enhancement nanostructure 600 can be comprised of a bow-tie shaped surface plasmon resonance structure 603 that resides on a metal adhesion layer 616, which lies on the surface of a substrate 602. The substrate 602 can be comprised of any appropriate dielectric material, such as fused silica, quartz, optical glasses such as BK7, SiO₂, silica, amorphous silicon, silicon nitride, etc.

The bow-tie shaped surface plasmon resonance structure 603 can be comprised of oppositely-directed portions (604a and 604b) that are separated by a gap region 606 (i.e., plasmon field enhancement region). As depicted, the oppositely-directed portions (604a and 604b) of the bow-tie shaped surface plasmon resonance structure 603 essentially form a dipole antennae structure. However, it should be appreciated that the bow-tie shaped surface plasmon resonance structure 603 can also take other forms or configurations including, but not limited to, a monopole or an enclosed bowtie. In one embodiment, the oppositely-directed portions (604a and 604b) have a trapezoidal shape. In another embodiment, the oppositely-directed portions (604a and 604b) have a rectangular shape. It should be appreciated, however, that the oppositely-directed portions (604a and 604b) can take any shape as long as the resulting nanostructure 600 can effectuate plasmonic enhancement at gap region 606.

The bow-tie shaped surface plasmon resonance structure 603 can be comprised of various metallic materials. For example, in one embodiment, the bow-tie shaped surface plasmon resonance structure 603 is comprised of gold (Au). In another embodiment, the bow-tie shaped surface plasmon resonance structure 603 is comprised of silver (Ag). In still another embodiment, the bow-tie shaped surface plasmon resonance structure 603 is comprised of aluminum (Al). In still yet another embodiment, the bow-tie shaped surface plasmon resonance structure 603 is comprised of a metal alloy. In a separate embodiment, the adhesion layer 616 is comprised of titanium (Ti). It should be understood, however, that the bow-tie shaped surface plasmon resonance structure 603 can be comprised of any metallic material that can concentrate a plasmonic field in gap region 606, including any of the coinage metals.

As shown in FIG. 6, the surface of the substrate 602 can be covered by a metal adhesion layer 616 (which can function to prevent loss of adhesion between the substrate 602 and the bow-tie shaped surface plasmon resonance structure 603). As shown herein, the adhesion layer 616 can be comprised of the same types of materials as the bow-tie shaped surface plasmon resonance structure 603. For example, in one embodiment, the adhesion layer 616 is comprised of gold (Au). In another embodiment, the adhesion layer 616 is comprised of silver (Ag). In still another embodiment, the adhesion layer 616 is comprised of aluminum (Al). In still yet another embodiment, the adhesion layer 616 is comprised of a metal alloy. It should be understood, however, that the adhesion layer 616 can be comprised of any metallic material that can concentrate a plasmonic field in gap region 606, including any of the coinage metals.

The dimensions of plasmonic nanostructure 600 can vary depending on the type of metal used (for the bow-tie shaped surface plasmon structure 603), the desired excitation wavelength, the desired emission wavelength, the desired size of the enhancement zone in gap region 606, the desired level of enhancement in the enhancement zone located in gap region 606, and the amount of enhancement in the volumes that are not located within gap region 606.

The enhancement zone in gap region 606 can be the volume in the nanostructure where enhancement is desired, and is depicted here as consisting of several volumes (v1 to v6). v1-v5 represents volumes that are about 10 nm thick covering the enhancement region 606 (the combined thickness of v1-v5 should approximate the thickness of the bow-tie shaped surface plasmon resonance structure 603), while v6 represents a volume that is about 6 nm thick covering a top region above the gap. The metal adhesion layer 616 can be applied as part of a separate process from the fabrication of metal structure 604.

In certain embodiments, it may be desirable to allow the SPP to continue into the gap region 606, resulting in higher enhancement levels, particularly in the volume closest to the substrate 602, which can result from utilization of the same material for metal adhesion layer 616 and the plasmon resonant structure 603.

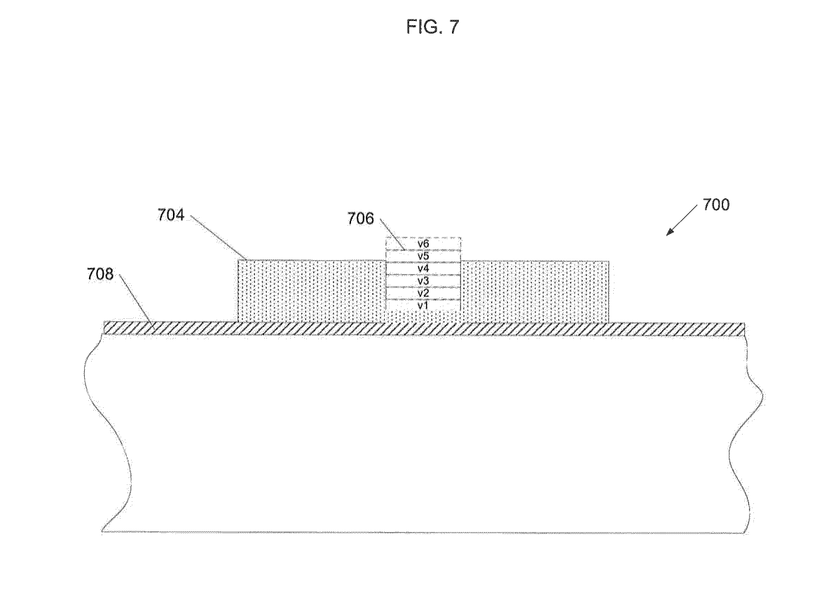

FIG. 7 shows a cross sectional side view of a bowtie plasmonic nanostructure with an adhesion layer, wherein the adhesion layer is not etched in the gap area between the two sections that comprise the bowtie and a cavity defined within the bowtie metal layer does not extend through to the adhesion layer, according to one embodiment. As shown herein, the bowtie plasmonic enhancement nanostructure 700 can be comprised of a bow-tie shaped surface plasmon resonance structure 703 that resides on an adhesion layer 702, which lies on the surface of a substrate 702. The substrate 702 can be comprised of any appropriate dielectric material, such as fused silica, quartz, optical glasses such as BK7, SiO₂, silica, amorphous silicon, silicon nitride, etc.

The bow-tie shaped surface plasmon resonance structure 703 can be comprised of oppositely-directed portions (704a and 704b) that are separated by a gap region 706 (i.e., plasmon field enhancement region). As depicted, the oppositely-directed portions (704a and 704b) of the bow-tie shaped surface plasmon resonance structure 703 essentially form a dipole antennae structure. However, it should be appreciated that the bow-tie shaped surface plasmon resonance structure 703 can also take other forms or configurations including, but not limited to, a monopole or an enclosed bowtie. In one embodiment, the oppositely-directed portions (704a and 704b) have a trapezoidal shape. In another embodiment, the oppositely-directed portions (704a and 704b) have a rectangular shape. It should be appreciated, however, that the oppositely-directed portions (704a and 704b) can take any shape as long as the resulting nanostructure can effectuate plasmonic enhancement at gap region 706.

The bow-tie shaped surface plasmon resonance structure 703 can be comprised of various metallic materials. For example, in one embodiment, the bow-tie shaped surface plasmon resonance structure 703 is comprised of gold (Au). In another embodiment, the bow-tie shaped surface plasmon resonance structure 703 is comprised of silver (Ag). In still another embodiment, the bow-tie shaped surface plasmon resonance structure 703 is comprised of aluminum (Al). In still yet another embodiment, the bow-tie shaped surface plasmon resonance structure 703 is comprised of a metal alloy. It should be understood, however, that the bow-tie shaped surface plasmon resonance structure 703 can be comprised of any metallic material that can concentrate a plasmonic field in gap region 706, including any of the coinage metals.

As shown in FIG. 7, the surface of the substrate 702 can be covered by an adhesion layer 708 (which can function to prevent loss of adhesion between the substrate 702 and the bow-tie shaped surface plasmon resonance structure 703). The adhesion layer 708 can be comprised of many different types of adhesion material including, but not limited to, a chromium-based material (Cr, Cr₂O₃, etc.), a titanium-based material (e.g., Ti, TiO₂, etc.), Al, Al₂O₃, Ta, Cu, Pb, amorphous Si, GaAs, other semiconducting materials, Chalcogenide glasses (which may also be amorphous, metal doped, or rare earth metal doped), and indium tin oxide (ITO).

As shown in FIG. 7, the adhesion layer can be intact in the enhancement region 706.

The dimensions of plasmonic nanostructure 700 can vary depending on the type of metal used (for the bow-tie shaped surface plasmon structure 703), the desired excitation wavelength, the desired emission wavelength, the desired size of the enhancement region 706, the desired level of enhancement in the enhancement region 706, and the amount of enhancement in the volumes that are not located within enhancement region 706.

Enhancement region 706 is the volume in the nanostructure where enhancement is desired, and is depicted as consisting of several volumes (v1 to v6). v1-v5 represent volumes that are about 10 nm thick covering the enhancement region (the combined thickness of v1-v5 should approximate the thickness of the bow-tie shaped surface plasmon resonance structure 703), while v6 represents a volume which is about 6 nm thick covering top region above the gap. As alluded to above, the bow-tie shaped surface plasmon resonance structure 703 is shown as being partly etched in the area under the enhancement region 706. That is, the cavity (i.e., enhancement region 706) defined within the bow-tie shaped surface plasmon resonance structure 703 does not extend through to the adhesion layer 708.

In certain embodiments, it may be desirable to minimize the enhancement nearest the substrate 700 (at the bottom) of enhancement region 706, which can result from utilization of an adhesion layer 708 that is of an appropriate material, such as Cr.

Structure 700 can optionally have a cover layer (not shown) similar to cover layer 510 in FIG. 5A.

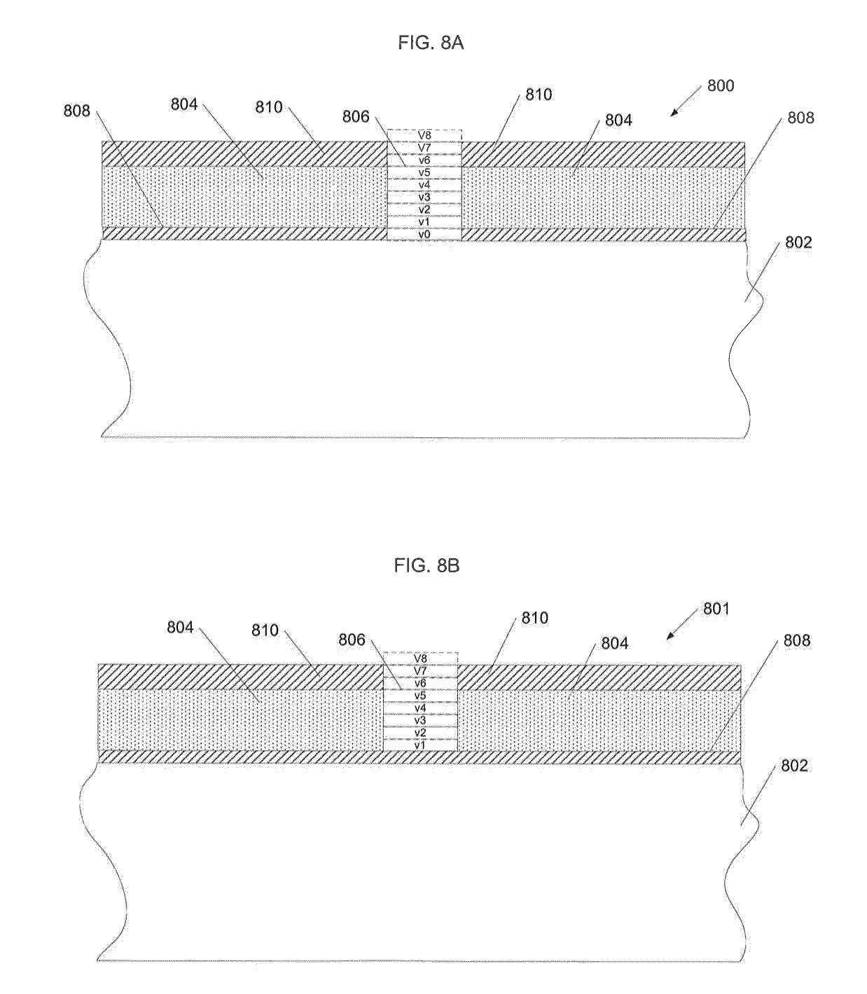

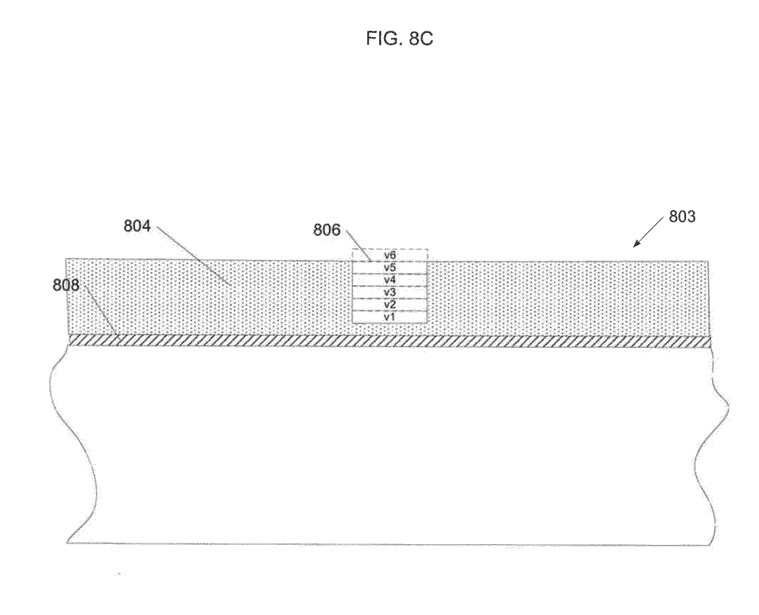

FIG. 8A shows a cross sectional side view of a plasmonic nanostructure comprised of a cavity defined through a cover layer, a metal layer and an adhesion layer, as further described herein according to one embodiment. As shown herein, the plasmonic enhancement nanostructure 800 is comprised of a cavity 806 (i.e., a nanochannel or a “zero mode waveguide”) that is defined (etched or masked) through a cover layer 810, metal layer 804 and adhesion layer 808, which are successively disposed onto the surface of a substrate 802. The substrate 802 can be comprised of any appropriate dielectric material, such as fused silica, quartz, optical glasses such as BK7, SiO₂, silica, amorphous silicon, silicon nitride, etc. The plasmon field enhancement region (i.e., gap region) essentially resides within the cavity 806.

As depicted, the plasmonic enhancement nanostructure 800 essentially forms a dipole antennae structure. However, it should be appreciated that the plasmonic enhancement nanostructure 800 can also take other forms or configurations including, but not limited to, a monopole.

In one embodiment, the cavity 806 is in the form of a nanochannel that is defined across a top surface of the cover layer 810 and extends through the metal layer 804 and the adhesion layer 808 to the top surface of the substrate 802. In another embodiment, the cavity 806 is in the form of a “zero mode waveguide” that extends through the cover layer 810, the metal layer 804 and the adhesion layer 808 to a top surface of the substrate 802. In one embodiment the “zero mode waveguide” can have a diameter of less than half the excitation wavelength. In another embodiment, the “zero mode waveguide” can have a diameter of greater than half the excitation wavelength.

The metal layer 804 can be comprised of various metallic materials. For example, in one embodiment, the metal layer 804 is comprised of gold (Au). In another embodiment, the metal layer 804 is comprised of silver (Ag). In still another embodiment, the metal layer 804 is comprised of aluminum (Al). In still yet another embodiment, the metal layer 804 is comprised of a metal alloy. It should be understood, however, that the metal layer 804 can be comprised of any metallic material that can concentrate a plasmonic field in the enhancement region located within the cavity 806, including any of the coinage metals.

As shown in FIG. 8A, the surface of the substrate 802 is covered by an adhesion layer 808 (which can function to prevent loss of adhesion between the substrate 802 and the metal layer 804). The adhesion layer 808 can be comprised of many different types of adhesion material including, but not limited to, a chromium-based material (Cr, Cr₂O₃, etc.), a titanium-based material (e.g., Ti, TiO₂, etc.), Al, Al₂O₃, Ta, Cu, Pb, amorphous Si, GaAs, other semiconducting materials, Chalcogenide glasses (which may also be amorphous, metal doped, or rare earth metal doped), and indium tin oxide (ITO).

The cover layer 810 can be made of materials which can adhere to metal layer 804, and can be comprised of materials that are similar to those used for adhesion layer 808 such as Cr, Cr₂O₃, a titanium-based material (e.g., Ti, TiO₂, etc.), Al, Al₂O₃, Ta, Cu, Pb, amorphous Si, GaAs, other semiconducting materials, Chalcogenide glasses (which may also be amorphous, metal doped, or rare earth metal doped), and indium tin oxide (ITO).

In one embodiment, the cover layer 810 can be configured to cause higher levels of enhancement in the volume closest to the substrate 802 (bottom) relative to the volume farthest from the substrate 802 (top) in the enhancement region. In another embodiment, cover layer 810 can be configured to cause lower levels of enhancement in the volume closest to the substrate 802 (bottom) relative to the volume farthest from the substrate 802 (top) in the enhancement region. In still another embodiment, cover layer 810 can be configured to cause similar levels of enhancement in the volume closest to the substrate 802 (bottom) relative to the volume farthest from the substrate 802 (top) in the enhancement region.

The dimensions of plasmonic nanostructure 800 can vary depending on the type of metal used in the metal layer 804, the desired excitation wavelength, the desired emission wavelength, the desired size of the enhancement region (within the cavity 806), the desired level of enhancement in the enhancement region, and the amount of enhancement in the volumes that are not located within enhancement region.

The enhancement region is the volume in the cavity 806 (defined within the cover layer 810, the metal layer 804 and the adhesion layer 808) where enhancement is desired, and is shown as consisting of several volumes (v0 to v8). v1-v5 can represent volumes that are each about 10 nm thick covering the enhancement region (the combined thickness of v1-v5 should approximate the thickness of the metal layer 804), while v0 can represent a volume within the masked or etched portion of the adhesion layer, v6-v7 can represent volumes in the etched portion of the cover layer 810, and v8 can represent a volume that is about 6 nm thick covering the top region above the cavity 806. Cover layer 810 is made of materials which can adhere to metal structure 804, and can be of materials similar to those used for the adhesion layer 808 such as Cr, Cr₂O₃, a titanium-based material (e.g., Ti, TiO₂, etc.), Al, Al₂O₃, Ta, Cu, Pb, amorphous Si, GaAs, other semiconducting materials, Chalcogenide glasses (which may also be amorphous, metal doped, or rare earth metal doped), and indium tin oxide (ITO).

In certain embodiments, it may be desirable to prevent loss of enhancement nearest the substrate 800 (at the bottom) of cavity 806, which can result from not etching through adhesion layer 808, thus permitting the use of materials for adhesion layer 808 which might otherwise reduce the enhancement in enhancement region.

FIG. 8B shows a cross sectional side view of a plasmonic nanostructure comprised of a cavity defined through a cover layer and a metal layer, according to one embodiment. As shown herein, the plasmonic enhancement nanostructure 801 is comprised of a cavity 806 (i.e., nanochannel or a “zero mode waveguide”) that is defined (etched or masked) through a cover layer 810 and a metal layer 804, which are successively disposed onto an adhesion layer 808 that lies on the surface of a substrate 802. The substrate 802 can be comprised of any appropriate dielectric material, such as fused silica, quartz, optical glasses such as BK7, SiO₂, silica, amorphous silicon, silicon nitride, etc.

As depicted, the plasmonic enhancement nanostructure 801 essentially forms a dipole antennae structure. However, it should be appreciated that the plasmonic enhancement nanostructure 801 can also take other forms or configurations including, but not limited to, a monopole.

In one embodiment, the cavity 806 is in the form of a nanochannel that is defined across a top surface of the cover layer 810 and extends through the metal layer 804 to the top surface of the adhesion layer 808. In another embodiment, the cavity 806 is in the form of a “zero mode waveguide” that extends through the cover layer 810 and the metal layer 804 to a top surface of the adhesion layer 808.

In one embodiment the “zero mode waveguide” can have a diameter of less than half the excitation wavelength. In another embodiment, the “zero mode waveguide” can have a diameter of greater than half the excitation wavelength.

The metal layer 804 can be comprised of various metallic materials. For example, in one embodiment, the metal layer 804 is comprised of gold (Au). In another embodiment, the metal layer 804 is comprised of silver (Ag). In still another embodiment, the metal layer 804 is comprised of aluminum (Al). In still yet another embodiment, the metal layer 804 is comprised of a metal alloy. It should be understood, however, that the metal layer 804 can be comprised of any metallic material that can concentrate a plasmonic field in the enhancement region located within cavity 806, including any of the coinage metals.

As shown in FIG. 8B, the surface of the substrate 802 is covered by an adhesion layer 808 (which can function to prevent loss of adhesion between the substrate 802 and the metal layer 804). The adhesion layer 808 can be comprised of many different types of adhesion material including, but not limited to, a chromium-based material (Cr, Cr₂O₃, etc.), a titanium-based material (e.g., Ti, TiO₂, etc.), Al, Al₂O₃, Ta, Cu, Pb, amorphous Si, GaAs, other semiconducting materials, Chalcogenide glasses (which may also be amorphous, metal doped, or rare earth metal doped), and indium tin oxide (ITO).

The cover layer 810 can be made of materials which can adhere to metal layer 804, and can be of materials similar to those used for the adhesion layer 808 such as Cr, Cr₂O₃,), a titanium-based material (e.g., Ti, TiO₂, etc.), Al, Al₂O₃, Ta, Cu, Pb, amorphous Si, GaAs, other semiconducting materials, Chalcogenide glasses (which may also be amorphous, metal doped, or rare earth metal doped), and indium tin oxide (ITO). In one embodiment, cover layer 810 can be configured to cause higher levels of enhancement in the volume closest to the substrate 802 (bottom) relative to the volume farthest from the substrate 802 (top) in the enhancement region. In another embodiment, cover layer 810 can be configured to cause lower levels of enhancement in the volume closest to the substrate 802 (bottom) relative to the volume farthest from the substrate 802 (top) in the enhancement region. In still another embodiment, cover layer 810 can be configured to cause similar levels of enhancement in the volume closest to the substrate 802 (bottom) relative to the volume farthest from the substrate 802 (top) in the enhancement region.

The dimensions of plasmonic nanostructure 801 can vary depending on the type of metal used in the metal layer 804, the desired excitation wavelength, the desired emission wavelength, the desired size of the enhancement region (within cavity 806), the desired level of enhancement in the enhancement region, and the amount of enhancement in the volumes that are not located within enhancement region.

The enhancement region is the volume in the cavity 806 (defined within the cover layer 810 and the metal layer 804) where enhancement is desired, and is shown as consisting of several volumes (v1 to v8). v1-v5 can represent volumes that are each about 10 nm thick covering the enhancement region (the combined thickness of v1-v5 should approximate the thickness of metal layer 804), v6-v7 can represent volumes in the etched portion of the cover layer 810, and v8 can represent a volume that is about 6 nm thick covering a top region above the cavity 806. Cover layer 810 is made of materials which can adhere to metal structure 804, and can be of materials similar to those used for adhesion layers such as Cr, Cr₂O₃, a titanium-based material (e.g., Ti, TiO₂, etc.), Al, Al₂O₃, Ta, Cu, Pb, amorphous Si, GaAs, other semiconducting materials, Chalcogenide glasses (which may also be amorphous, metal doped, or rare earth metal doped), and indium tin oxide (ITO).

In certain embodiments, it may be desirable to minimize the enhancement nearest the substrate 802 (at the bottom) of cavity 806, which can result from utilization of an adhesion layer 808 that is of an appropriate material, such as Cr, and is not etched or masked at the bottom of the cavity 806.

FIG. 8C shows a cross sectional side view of a plasmonic nanostructure comprised of a cavity that is defined in a metal layer but not through to an adhesion layer, according to one embodiment. As shown herein, the plasmonic enhancement nanostructure 803 can be comprised of a cavity 806 (i.e., a nanochannel or a “zero mode waveguide”) that is defined (etched or masked) into a metal layer 804 which is disposed onto an adhesion layer 808 that lies on the surface of a substrate 802. The substrate 802 can be comprised of any appropriate dielectric material, such as fused silica, quartz, optical glasses such as BK7, SiO₂, silica, amorphous silicon, silicon nitride, etc.

As depicted, the plasmonic enhancement nanostructure 803 essentially forms a dipole antennae structure. However, it should be appreciated that the plasmonic enhancement nanostructure 803 can also take other forms or configurations including, but not limited to, a monopole.

In one embodiment, the cavity 806 is in the form of a nanochannel that is defined across a top surface of metal layer 804 that is disposed on top of adhesion layer 808.

In another embodiment, the cavity 806 is in the form of a “zero mode waveguide” that extends into the metal layer 804 but not through to a top surface of adhesion layer 808.

In one embodiment the “zero mode waveguide” can have a diameter of less than half the excitation wavelength. In another embodiment, the “zero mode waveguide” can have a diameter of greater than half the excitation wavelength.

The metal layer 804 can be comprised of various metallic materials. For example, in one embodiment, the metal layer 804 is comprised of gold (Au). In another embodiment, the metal layer 804 is comprised of silver (Ag). In still another embodiment, the metal layer 804 is comprised of aluminum (Al). In still yet another embodiment, the metal layer 804 is comprised of a metal alloy. It should be understood, however, that the metal layer 804 can be comprised of any metallic material that can concentrate a plasmonic field in the enhancement region located within cavity 806, including any of the coinage metals.

As shown in FIG. 8C, the surface of the substrate 802 is covered by an adhesion layer 808 (which can function to prevent loss of adhesion between the substrate 802 and the metal layer 804). The adhesion layer 808 can be comprised of many different types of adhesion material including, but not limited to, a chromium-based material (Cr, Cr₂O₃, etc.), a titanium-based material (e.g., Ti, TiO₂, etc.), Al, Al₂O₃, Ta, Cu, Pb, amorphous Si, GaAs, other semiconducting materials, Chalcogenide glasses (which may also be amorphous, metal doped, or rare earth metal doped), and indium tin oxide (ITO).

The dimensions of plasmonic nanostructure 803 can vary depending on the type of metal used in the metal layer 804, the desired excitation wavelength, the desired emission wavelength, the desired size of the enhancement region (within cavity 806), the desired level of enhancement in the enhancement region, and the amount of enhancement in the volumes that are not located within enhancement region.

The enhancement region is the volume in the cavity 806 (defined within the cover layer 810 and the metal layer 804) where enhancement is desired, and is shown as consisting of several volumes (v1 to v6). v1-v5 can represent volumes that are each about 10 nm thick covering the enhancement region, v6 can represent a volume that is about 6 nm thick covering a top region above the cavity 806.

Plasmonic nanostructure 803 can optionally have a cover layer (not shown) similar to cover layer 510 in FIG. 5A. In one embodiment, it may be desirable to allow the SPP to continue into the cavity 806, resulting in higher enhancement levels, particularly in the volume closest to the substrate 802, which can result from not fully etching through the metal layer 804. In another embodiment, it may be desirable to allow the SPP to continue into the cavity 806, resulting in higher enhancement levels, particularly in the volume closest to the substrate 802, which can result from utilization of the same material for a metal adhesion layer (not shown) and the plasmon resonant structure 803.

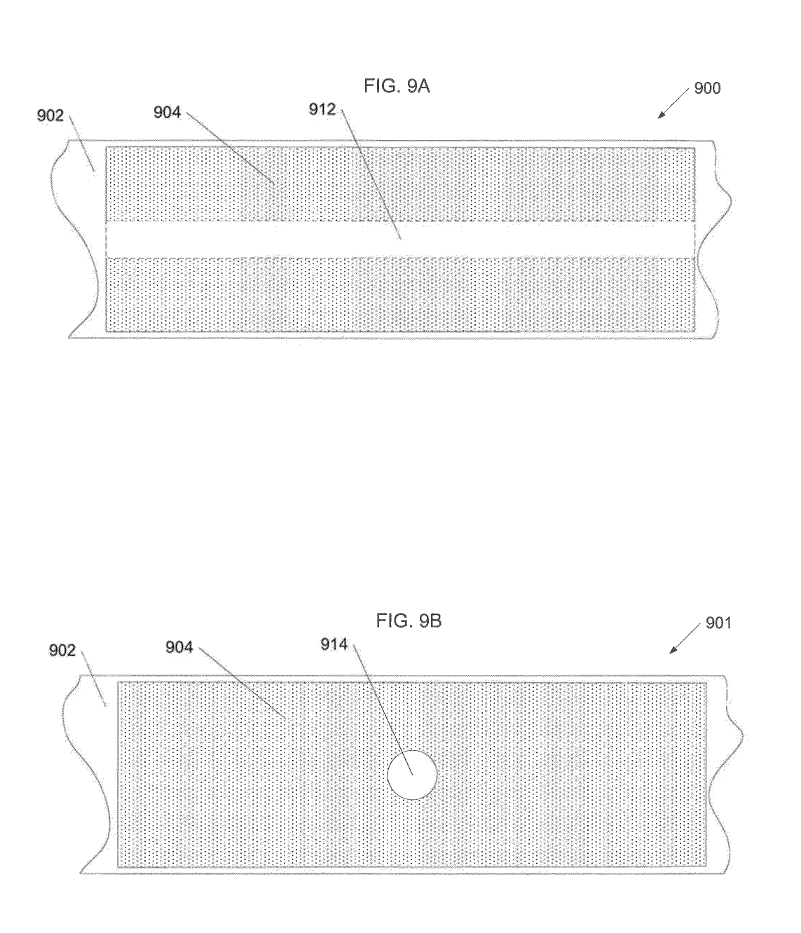

FIG. 9A shows a top view of a plasmonic enhancement nanochannel structure 900, according to one embodiment. As shown herein, the nanochannel 912 is defined (etched or masked) across a top surface layer 904 that lies on top of a substrate 902. The substrate 902 can be comprised of any appropriate dielectric material, such as fused silica, quartz, optical glasses such as BK7, SiO₂, silica, amorphous silicon, silicon nitride, etc.

Typically, the top surface layer 904 is comprised of a multi-layer stack. In one embodiment the multi-layer stack is comprised of a cover layer, a metal layer and an adhesion layer. In another embodiment, the multi-layer stack is comprised of a metal layer and an adhesion layer. However, it should be appreciated that there are also certain applications that call for the top surface layer 904 to be comprised of just a single metal layer.

The dimensions of plasmonic nanochannel structure 900 can vary depending on the type of metal used, the desired excitation wavelength, the desired emission wavelength, the desired size of the enhancement region (located within the nanochannel 912), the desired level of enhancement in the enhancement region (not shown), and the amount of enhancement in the volumes that are not located within the enhancement region (not shown).

In one embodiment, the nanochannel 912 extends through the top surface layer 904 on to the top surface of the substrate 902. In another embodiment, the nanochannel 912 extends into the top surface layer 904, but not through to the top surface of the substrate 902. It should be understood that the penetration of nanochannel 902 into the layer(s) that comprise the top surface layer 904 depends on the requirements of the particular application. For example, it may depend on the desired size and/or location of the enhancement region and the level of enhancement required by the application.

In one embodiment, the top surface layer 904 includes only a single nanochannel 912. In another embodiment, top surface layer 904 includes a plurality of nanochannels 912.

In one embodiment, the plurality of nanochannels 912 can be in parallel and be spaced to permit plasmonic resonance between nanochannels 912. In another embodiment, the spacings can alternate between two different distances, so as to create resonances at two different plasmonic frequencies.

In one embodiment, different resonances can also be generated on the top and bottom surfaces of the plasmonic enhancement nanochannel structure 900. Such resonances can be optimized for fluorophore excitation, fluorophore emission, Qdot excitation, or optimized for a combination of the above.

In one embodiment, nanochannel 912 can be interconnected in a grid pattern. The grid pattern can be a regular grid or irregular grid. In one embodiment, the widths of the nanochannels 912 are the same. In another embodiment, the widths of each nanochannel 912 can have different widths from at least one of the other nanochannels 912.

The nanochannel 912 can be of various lengths and widths depending on the requirements of the particular application. For example, nanochannel 912 can have a width that ranges from between about 20 nm to about 1000 nm, about 30 nm to about 300 nm, about 30 nm to about 150 nm, about 40 to about 120 nm or about 50 nm to about 75 nm. The length of nanochannel 912 can range from between about 100 nm to about 10 cm. In one embodiment, the nanochannel 912 has a width of less than half of the wavelength of the excitation light. In another embodiment, the nanochannel 912 has a width of greater than half the wavelength of the excitation light.

In one embodiment, the plasmonic enhancement nanochannel structure 900 is configured with dimensions and a top surface layer 904 composition that effectuates an average plasmon enhancement ratio in the enhancement region (located within the nanochannel 912) that is similar for the different volumes with varying position in z (where z is considered to be perpendicular to the substrate 902). In another embodiment, plasmonic enhancement nanochannel structure 900 is configured with dimensions and a top surface layer 904 composition that effectuates an average enhancement ratio in the enhancement region (located within the nanochannel 912) that is higher for volumes closer to the substrate 902 (bottom) for different volumes with varying position in z (where z is considered to be perpendicular to the substrate 902). In still another embodiment, plasmonic enhancement nanochannel structure 900 is configured with dimensions and a top surface layer 904 composition that effectuates an average enhancement ratio in the enhancement region (located within the nanochannel 912) that is higher for volumes farthest from the substrate 902 for different volumes with varying position in z (where z is considered to be perpendicular to the substrate 902). In still other embodiments, plasmonic enhancement nanochannel structure 900 is configured with dimensions and a top surface layer 904 composition that effectuates an enhancement ratio between the top volume and bottom volume that can be about 20:1, about 10:1, about 5:1, about 2:1, about 1:1, about 1:2, about 1:5, about 1:10, or about 1:20 for a particular wavelength.

FIG. 9B shows a top view of a plasmonic enhancement nanowell structure 901, according to one embodiment. As shown herein, the nanowell 914 is defined (etched or masked) into a top surface layer 904 that lies on top of a substrate 902. The substrate 902 can be comprised of any appropriate dielectric material, such as fused silica, quartz, optical glasses such as BK7, SiO₂, silica, amorphous silicon, silicon nitride, etc.

Typically, the top surface layer 904 is comprised of a multi-layer stack. In one embodiment the multi-layer stack is comprised of a cover layer, a metal layer and an adhesion layer. In another embodiment, the multi-layer stack is comprised of a metal layer and an adhesion layer. In yet another embodiment, the multi-layer stack is comprised of a metal adhesion layer, a metal layer and a cover layer. In still yet another embodiment, the multi-layer stack is comprised of an adhesion layer, a metal adhesion layer, and a metal layer. In a different embodiment, the multi-layer stack is comprised of an adhesion layer, a metal adhesion layer, a metal layer, and a cover layer. However, it should be appreciated that there are also certain applications that call for the top surface layer 904 to be comprised of just a single metal layer.

As depicted, the nanowell 914 essentially functions as a “zero mode waveguide”. In one embodiment, nanowell 914 can have a diameter of less than half the excitation wavelength. In another embodiment, nanowell 914 can have a diameter of greater than half the excitation wavelength. It should be understood that nanowell 914 can take any shape as long as the resulting nanostructure can effectuate plasmonic enhancement, such as bow-tie apertures, a bow-tie trench structure as described in U.S. patent application Ser. No. 12/284,109 (filed Sep. 18, 2008), H apertures, and C apertures.

The dimensions of nanowell plasmonic nanostructure 901 can vary depending on the type of metal used, the desired excitation wavelength, the desired emission wavelength, the desired size of the enhancement region (located within the nanowell 914), the desired level of enhancement in the enhancement region (not shown), and the amount of enhancement in the volumes that are not located within enhancement region (not shown).

In one embodiment, a plurality of nanowells 914 is arranged in a regular pattern. For example, the regular patterns can be rectangular, square, hexagonal, or any other regular pattern. In an alternative embodiment, the plurality of nanowells 914 is arranged in an irregular pattern. That is, the nanowells 914 are randomly spaced apart such that resonances between nanowells 914 are generated. Such resonances can be optimized for fluorophore excitation, fluorophore emission, frequencies on the top and bottom portions of the nanowell 914, Qdot excitation, or optimized for a combination of the above.

The above-mentioned embodiments of resonant/enhancement plasmonic nanostructures can be used in various types of detection systems. For example, these plasmonic nanostructures can be used in single molecule sequencing detection systems. In particular, systems employed in connection with sequencing by synthesis, in which the incorporation of an individual nucleotide (e.g., including a single base or multiple bases) into a nucleic acid during replication is detected. Generally, during a sequence by synthesis run, as nucleotides are incorporated into a nucleic acid (via a nucleic acid replicating catalyst such as a DNA or RNA polymerase) that is complementary to the target nucleic acid, an associated label (e.g., fluorophore) is rendered able to emit light. One or more properties of the emitted light (e.g., wavelength) are used to identify the incorporated nucleotide. Within this system construct, the above-described resonant and/or focusing structures can be utilized to concentrate resonance energy or focus plasmonic fields to specific areas (i.e., detection volumes) where the labels reside to enhance their emission profile and/or to lower background signal noise.

Although there can be areas with lower (or no) enhancement, the signal produced by the labels in those locations will be proportionally lower, and similarly, there can be proportionally more enhancement in regions with high enhancement relative to areas with lower or no enhancement. Thus in one embodiment, if the enhancement in the desired location is sufficiently higher than in desired locations than in unintended locations, the signal from fluorophores in the unintended locations can be filtered out as background using software.

Furthermore, the various embodiments of plasmonic nanostructures described above can be used for biomolecule detection such as protein detection using antibody receptors or ligands, hybridization, activation of photo-cleavable linkers/photo-activated attachments, etc. It should be appreciated, however, that these are just some exemplary examples of the types detection systems that these plasmonic structures can be used in and that in practice these structures can be used in any detection system that can be improved by the resonance and/or plasmon field enhancing properties of these structures.

The following experimental results are offered to illustrate but not to limit the embodiments described herein.

### Experimental Results

Three-dimensional electromagnetic simulations were performed using Lumerical FDTD Solutions on an 8-core PC with 16˜GB of memory. The size of the computational region was 2×2×0.6 μm. Antisymmetric and symmetric boundaries were used in the middle of the x and y directions because of the symmetry of the structure and the source, which reduces the calculation and memory overhead without sacrificing resolution. Perfectly matched layers (PML) were used on the other boundaries. The area around the structure used a grid size of 3×3×2 nm, while the other parts of the simulation region have a grid size smaller than 10 nm. This helps to increase the calculation accuracy of the metallic structure. The total-field-scattered-field source is used to introduce a perfect plane wave inside the substrate. Slice monitors were used to calculate the averaged near-field intensity within different regions within and above the gap: v1-v5 represent volumes with 10 nm thickness inside the gap, and v0 denotes the volume covering the gap region formed by an etched cover/metal/adhesion layer(s).

FIG. 2B is a graph that depicts the average level of enhancement (|E|²) in different volumes in the gap of the conventional bowtie plasmonic nanostructure of FIG. 2A versus the incident wavelength for the bowtie antenna without an adhesion layer as shown in FIG. 2A. The dimensions of nanostructure 200 are those used in describing FIG. 1B, consisting of a pair of oppositely-directed trapezoidal segments, which form the bowtie antenna, supported by a semi-infinite glass (SiO₂) substrate and covered by air. An x-polarized plane wave with unit amplitude (1˜V/m) normally illuminates the structure from the bottom. The plots for v1-v5 represent the average simulated enhancement as described previously, resulting from volumes with 10 nm thickness covering the enhancement region, while the plot for v6 represents the average simulated enhancement corresponding to a volume with 6 nm thickness covering the region above (furthest from the substrate 202) the gap. v1 represents the volume in the enhancement region 206 closest to the substrate (bottom), while volume v5 represents the volume in the enhancement region 206 farthest from the substrate (top).

It can be seen in FIG. 2B that the average enhancement level (|E|²) in the different volumes of enhancement region 206 are fairly similar, thus providing relatively similarly uniform excitation for fluorophores at any z location within the enhancement region 206. The peak positions at the different slices are the same (λ=630 nm) even though the surrounding is asymmetric. The top and bottom slices have the highest fields, and the field decays to a minimum in the middle. The peaks are expected to be formed by the resonant behavior of the SR-SPP propagating along the x direction of the structure, based on the concept of retardation-based resonances. The same propagation constant of the SR-SPP across the entire structure causes the same peak position at the different volumes in the gap region, while the asymmetric surrounding only shifts the higher field enhancement to the interface with the higher dielectric constant, here, the bottom interface. The upper volume (v6) has nearly identical enhancement to v5, because the resonance at the top of the gap extends above and below the surface.

FIG. 3B is a graph that depicts the average level of enhancement (|E|²) in different volumes in the gap of the bowtie plasmonic nanostructure of FIG. 3A versus the incident wavelength for the bowtie antenna with an adhesion layer in accordance with the nanostructure 300 of FIG. 3A. The dimensions of nanostructure 300 are those used in describing FIG. 1B, consisting of a pair of oppositely-directed trapezoidal segments, which form the bowtie antenna, supported by a semi-infinite glass (SiO₂) substrate and covered by air.

An x-polarized plane wave with unit amplitude (1˜V/m) normally illuminates the structure from the bottom. The plots for v1-v5 represent the average simulated enhancement as described previously, resulting from volumes with 10 nm thickness covering the enhancement region, while the plot for v0 represents the average simulated enhancement as previously described for the volume within the masked or etched portion of the adhesion layer, and the plot for v6 represents the average simulated enhancement as described previously corresponding to a volume with 6 nm thickness covering the region above (furthest from the substrate 302) the enhancement region. v1 represents the volume in the enhancement region 306 closest to the substrate (bottom), while volume v5 represents the volume in the enhancement region 306 farthest from the substrate (top).

The nanostructure 300 exhibits a resonance peak at 560 nm and has a second, red-shifted, peak at 660 nm as shown in FIG. 3B. The intensity distribution of the second peak presents the same coupled and standing-wave patterns as the structure without an adhesion layer, indicating the resonance properties of the SR-SPP that are similar to those of structure 200 in FIG. 2. However the field pattern of the first peak is different: this field also exhibits a standing-wave pattern on the top surface, but with monotonic decay along the z direction. This is consistent with the characteristics of an uncoupled SPP; the first peak is generated by the resonant behavior of an SPP on the top surface. This is supported by the fact that the average intensity within v6 is greater than v5 at the first peak, because the SPP mode extends further above the top surface than the SR-SPP resonance.

In order to further confirm the resonant information of the first peak (560 nm) of the structure with a Cr₂O₃ layer, the spatial distributions of magnitude and phase of Eₓ and E_{z} are simulated. Compared with the corresponding simulations of the structure without an adhesion layer, the distribution of E_{z} magnitude is similar, which also localizes on the top and bottom corners. However, the distribution of Eₓ magnitude is different, which mainly localizes on the top surface and monotonically decays from top to bottom. It represents the field pattern of an SPP on the top surface. Furthermore, the different symmetry of the magnitude and phase implies different resonant processes. The disappearance of the symmetric coupled field inside the gold structure indicates the disappearance of the coupled SR-SPP mode at this wavelength. Moreover, the symmetry of amplitude and phase inside the gap region is unchanged, which means the G-SPP still exists inside the gap, in this case, due to the coupling of the top surface SPP modes in each trapezoidal region.

FIG. 4B is a graph that depicts the average level of enhancement (|E|²) in different volumes in the gap of the bowtie plasmonic nanostructure of FIG. 4A versus the incident wavelength for the bowtie antenna with an adhesion layer in accordance with the nanostructure 400 of FIG. 4A. The dimensions of nanostructure 400 are those used in describing FIG. 1B, consisting of a pair of oppositely-directed trapezoidal segments, which form the bowtie antenna, supported by a semi-infinite glass (SiO₂) substrate and covered by air.

An x-polarized plane wave with unit amplitude (1˜V/m) normally illuminates the structure from the bottom. The plots for v1-v5 represent the average simulated enhancement as described previously, resulting from volumes with 10 nm thickness covering the enhancement region, and the plot for v6 represents the average simulated enhancement as described previously corresponding to a volume with 6 nm thickness covering the region above (furthest from the substrate 402) the enhancement region. v1 represents the volume in the enhancement region 406 closest to the substrate (bottom), while volume v5 represents the volume in the enhancement region 406 farthest from the substrate (top).

The nanostructure 400 exhibits a resonance peak at 560 nm and has a second, red-shifted, peak at 820 nm as shown in FIG. 4B. The intensity distribution of the second peak presents the same coupled and standing-wave patterns as the structure without an adhesion layer, indicating the resonance properties of the SR-SPP that are similar to those of structure 200 in FIG. 2. However the field pattern of the first peak is different: this field also exhibits a standing-wave pattern on the top surface, but with monotonic decay along the z direction. This is consistent with the characteristics of an uncoupled SPP; the first peak is generated by the resonant behavior of an SPP on the top surface. This is supported by the fact that the average intensity within v6 is greater than v5 at the first peak, because the SPP mode extends further above the top surface than the SR-SPP resonance.

In order to further confirm the resonant information of the first peak (560 nm) of the structure with a Cr₂O₃ layer, the spatial distributions of magnitude and phase of Eₓ and E_{z} are simulated. Compared with the corresponding simulations of the structure without an adhesion layer, the distribution of E_{z} magnitude is similar, which also localizes on the top and bottom corners. However, the distribution of Eₓ magnitude is different, which mainly localizes on the top surface and monotonically decays from top to bottom. It represents the field pattern of an SPP on the top surface. Furthermore, the different symmetry of the magnitude and phase implies different resonant processes. The disappearance of the symmetric coupled field inside the gold structure indicates the disappearance of the coupled SR-SPP mode at this wavelength. Moreover, the symmetry of amplitude and phase inside the gap region is unchanged, which means the G-SPP still exists inside the gap, in this case, due to the coupling of the top surface SPP modes in each trapezoidal region.

After clarifying the physical meaning of these peaks in FIGS. 3B and 4B, it is clear to one of skill in the art that the dielectric adhesion layer (Cr₂O₃) causes the peak of the SR-SPP to red-shift. The reason is that the high refractive index of Cr₂O₃ increases the effective refractive index of the substrate. Although the thickness of the Cr₂O₃ layer is quite thin (6 nm is much smaller than the skin depth), the resonant behavior of the SR-SPP is still influenced due to its high sensitivity to the surrounding. From the coupled equation of the metal film in asymmetric surroundings, we know that increase of the refractive index of the substrate will decrease the effective wavelength of SR-SPP, so the incident wavelength should be red-shifted in order to satisfy the resonant condition again. Furthermore, the magnitude of red shift depends on the coverage of the adhesion layer. The continuous adhesion layer covers the bottom of the gap and the bottom corners of the structure, which are regions of strong field localization, causing a greater red shift. Another effect of the high index adhesion layer is a greater Fresnel reflection at the interface with illumination from below, which decreases the overall intensity of the resonances. It should be noted that the resonance of SPP modes on the top and bottom surfaces should always exist in the structure with or without an adhesion layer. From simulation data, the peak of top SPP is at λ=560 nm with value about 10 (V/m)². However from the FIG. 3C the peak of the SR-SPP for the case of nanostructure without the adhesion layer 200 is at λ=630 nm and the peak value is about 50 (V/m)². The peak of the SR-SPP is so remarkable that it hides the adjacent peak of the SPP. For the case of nanostructure with the etched adhesion layer 300, the red-shift is not enough so that the SPP peaks are obscured. For the case of nanostructure with a continuous adhesion layer 400, the greater red-shift of the peak of the SR-SPP reveals the peak of the top SPP. However, the peak of the bottom SPP is still hidden. It is because the propagation constant of SR-SPP mode will approach that of the SPP mode on the bottom surface with increasing effective refractive index of the substrate.

FIG. 3C is a graph that shows data from simulations of a nanostructure 300 as described in FIG. 3A, specifically near-field resonance curves of average |E|² in the top gap volumes in the enhancement region 306 versus the incident wavelength with adhesion layer 308 of different thicknesses. The thickness of adhesion layers is 6, 10 and 20 nm in these simulations.

FIG. 3C shows that only the top slice represents both of the SR-SPP and SPP resonances. The average |E|² in the top slice (v5) versus the incident wavelength is graphed in FIG. 3C. The curves of Cr₂O₃ adhesion layers with different thicknesses show that increasing the thickness also causes the peak of the SR-SPP to red-shift with a decrease in the overall intensity; the effective refractive index of the substrate is increased. The peak position of the top surface SPP mode is unchanged due to the surrounding of the top surface not changing. A gradual separation of the SR-SPP and SPP peaks is shown in FIG. 3C.

FIG. 3D is a graph that shows data from simulations of nanostructure 300 as described in FIG. 3A, specifically near-field resonance curves of average |E|² in the top gap volumes in the enhancement region 306 versus the incident wavelength with adhesion layer 308 of different materials. The materials of the adhesion layers are TiO₂, Cr₂O₃, Ti, Cr, and ITO in these simulations. The thickness of adhesion layers is 6 nm in these simulations, according to practical fabrication. The near-field resonance curves of average |E|² in the different gap volumes in the enhancement region 306 versus the incident wavelength. The nanostructure 300 exhibits a resonance peak at 560 nm.

Similar phenomena are shown in the curves for adhesion layers of different materials in FIG. 3D. Different materials change the peak position of the SR-SPP and the magnitude of the curves, but do not significantly change the peak position or magnitude of the top SPP resonance. Titanium and Cr have high absorption, and for a continuous adhesion layer, the SR-SPP mode is totally quenched. For Ti, overall suppression is not as strong due to its lower extinction coefficient. Titanium dioxide causes less red shift of the SR-SPP peak than Cr₂O₃ and has significantly higher magnitude due to lower absorption. The influence of ITO is between that of Cr₂O₃ and titanium dioxide. As before, etched layers result in less red shift and higher intensity levels, where for Cr and Ti, the SR-SPP and top SPP modes overlap.

In summary, the influence of adhesion layers mainly lies on two factors: refractive index and the absorption of the material. High refractive index causes the peak of the SR-SPP to red-shift. High absorption quenches the intensity of the SR-SPP. For the case of the continuous dielectric adhesion layer, there is a strong influence on the SR-SPP; sufficient red-shift of the SR-SPP peak reveals the resonant peak of the SPP on the top surface, which has different near-field localization, with monotonic decay along the z direction from top to bottom. The combined influence of the two factors for the case of the etched metal adhesion layer causes the peaks of the different slice volumes to separate and red-shift from top to bottom, which is useful for the optimization of optical confinement considered.

FIG. 5B is a graph that depicts the average level of enhancement in different volumes in the gap of the bowtie plasmonic nanostructure of FIG. 5A versus the incident wavelength for the bowtie antenna with an adhesion layer in accordance with the nanostructure 500 of FIG. 5A. The dimensions of nanostructure 500 are those used in describing FIG. 1B, consisting of a pair of oppositely-directed trapezoidal segments, which form the bowtie antenna, supported by a semi-infinite glass (SiO₂) substrate and covered by air.

Field localization, i.e. optical confinement, is of critical importance for single molecule detection. In one embodiment, light illumination from the bottom is used to generate highly localized fields at the bottom surface of a sub-wavelength aperture. The “aperture” or cavity is the gap region of the bowtie antenna. In this embodiment, the ideal field pattern is one that is highly localized at the bottom surface and decays towards the top surface inside the gap region, similar to the evanescent field in the so-called zero-mode waveguide.

Based on the simulation of structures without adhesion layers such as structure 200, the coupling of the SR-SPP mode in the gap exhibits field localization both at the top and bottom surface, which is not ideal. Alternatively, an etched metallic layer can separate the enhancement peaks at different heights in the gap region. In one embodiment, a structure comprises a combination of an etched TiO₂ layer on the bottom and an etched Cr layer on the top is. The low absorption and refractive index of TiO₂ will minimize the influence on the peak level and peak position of the SR-SPP resonance. The high absorption of Cr will quench the field on the top region (both the SPP and, to a lesser extent, the SR-SPP) and shift the resonance in the bottom region to towards the SPP mode on the bottom surface.

The average |E|² in the different gap volumes as a function of the incident wavelength for the structure with 6 nm etched TiO₂ bottom layer and 20 nm etched Cr top layer is shown in FIG. 5B. Data for two additional volumes with 10 nm thickness, named v6 and v7, are added within the gap formed by the 20 nm etched Cr cover layer, and v8 denotes a monitor with 6 nm thickness covering the top region above the gap. FIG. 5B shows that the peak of the top region is red-shifted and reduced due to the high refractive index and high absorption of the Cr cover, and the peak of bottom region is blue-shifted to that of SPP mode on bottom surface. Simulation shows that the intensity of the top surface is quenched, and the optimized field inside the gap almost monotonically decays from bottom to top, which effectively decreases the optical volume. Through calculating the ratio of the effective volume of the field inside the gap region to the volume of gap, we know that the volume ratio is reduced from 0.81 to 0.53. Furthermore, the greatest enhancement ratio within the gap is ˜410, which is almost the same as the enhancement ration for a structure without an adhesion layer (˜420).

Simulation gives similar results for bowtie plasmonic structures with thinner layers of gold (e.g. 30 nm).

Next, the influence of metal adhesion layers is considered. The average |E|² in the different gap volumes versus the incident wavelength for the structures with continuous (as shown in FIG. 6A) and etched Cr layers are considered. From simulation, it is clear that both exhibit a single distinct peak at 560˜nm, which is due to the SPP on the top surface. The SR-SPP peaks disappear because of strong attenuation by the Cr layer, in addition to some red-shift.

Much different resonant behavior occurs the etched layer. The peak positions of different slices are red-shifted from top to bottom; these peaks are associated with overlap of the SR-SPP and top SPP modes. The red-shift of the bottom peak is due to the influence of the high refractive index on the SR-SPP mode, which is also partly quenched due to the absorption of the metal layer. The bottom absorbing layer does not significantly influence the intensity of top SPP, which is mainly localized on the opposite side of the structure. Moreover, the red-shift of the SR-SPP peak is small since the metal layer lies only beneath the trapezoidal segments, which means the peaks of SR-SPP and the top SP overlap. Therefore, the peak position at the top slice approaches that of the SPP mode on the top surface (˜560 nm), whereas the peak at the bottom slice is due almost entirely to the red-shifted (and attenuated) SR-SPP mode. Moreover, both structures have greater average intensity in v6 than v5, which also implies similar field extension as the SPP resonance of the first peaks as for those that occur when using a Cr₂O₃ adhesion layer.

While certain embodiments have been described above, it will be understood that the embodiments are described by way of example only. Those skilled in the art will appreciate that the same can be performed within a wide range of equivalent parameters, concentrations, and conditions without departing from the spirit and scope of the embodiments disclosed herein and without undue experimentation. Accordingly, the compositions/compounds, apparatuses, systems, processes and/or methods described herein should only be limited in light of the claims that follow when taken in conjunction with the above description and accompanying drawings.

1. A plasmonic nanostructure for enhanced light excitation, comprising:
a substrate;
an adhesion layer disposed on top of the substrate;
a surface plasmon resonance layer disposed on top of the adhesion layer; and
a cavity extending into the surface plasmon resonance layer, wherein the surface plasmon resonance layer is configured to concentrate an applied plasmon field to a bottom portion of the cavity.

2. The plasmonic nanostructure for enhanced light excitation, as recited in claim 1, further including a cover layer disposed on a top surface of the surface plasmon resonance layer, the cover layer configured to disperse the applied plasmon field at a top portion of the cavity.

3. The plasmonic nanostructure for enhanced light excitation, as recited in claim 2, wherein the plasmon field strength is greater at the bottom portion than at the top portion.

4. The plasmonic nanostructure for enhanced light excitation, as recited in claim 2, wherein the cavity further extends through the surface plasmon resonance layer to a top surface of the adhesion layer.

5. The plasmonic nanostructure for enhanced light excitation, as recited in claim 4, wherein the cavity further extends through the adhesion layer to a top surface of the substrate.

6. The plasmonic nanostructure for enhanced light excitation, as recited in claim 1, wherein the surface plasmon resonance layer is a metal or metal alloy.

7. (canceled)

8. The plasmonic nanostructure for enhanced light excitation, as recited in claim 1, wherein the adhesion layer is a chromium based material.

9. (canceled)

10. (canceled)

11. The plasmonic nanostructure for enhanced light excitation, as recited in claim 1, wherein the adhesion layer is a titanium based material.

12. (canceled)

13. (canceled)

14. The plasmonic nanostructure for enhanced light excitation, as recited in claim 1, wherein the adhesion layer is indium tin oxide (ITO).

15. The plasmonic nanostructure for enhanced light excitation, as recited in claim 2, wherein the cover layer is a chromium based material.

16. (canceled)

17. (canceled)

18. The plasmonic nanostructure for enhanced light excitation, as recited in claim 2, wherein the cover layer is titanium dioxide (TiO₂).

19. The plasmonic nanostructure for enhanced light excitation, as recited in claim 2, wherein the cover layer is indium tin oxide (ITO).

20. A plasmonic nanostructure for enhanced light excitation, comprising:
a substrate;
an adhesion layer disposed on top of the substrate; and
a bow-tie shaped surface plasmon resonance structure disposed on top of the adhesion layer, the bow-tie shaped surface plasmon resonance structure comprised of,
a first oppositely-directed isosceles trapezoidal portion and a second oppositely-directed isosceles trapezoidal portion, and
a plasmon field enhancement region located in between the oppositely-directed isosceles trapezoidal portions, wherein the bow-tie shaped surface plasmon resonance structure is configured to concentrate an applied plasmon field to a bottom portion of the plasmon field enhancement region.

21. The plasmonic nanostructure for enhanced light excitation, as recited in claim 20, further including a cover layer disposed on a top surface of the bow-tie shaped surface plasmon structure, wherein the cover layer is configured to disperse an applied plasmon field at a top portion of the plasmon field enhancement region.

22. The plasmonic nanostructure for enhanced light excitation, as recited in claim 21, wherein the plasmon field strength is greater at the bottom portion than at the top portion.

23. The plasmonic nanostructure for enhanced light excitation, as recited in claim 21, wherein the adhesion layer extends to the boundaries of the bow-tie shaped surface plasmon resonance structure.

24. The plasmonic nanostructure for enhanced light excitation, as recited in claim 20, wherein the surface plasmon resonance layer is a metal or metal alloy.

25. (canceled)

26. The plasmonic nanostructure for enhanced light excitation, as recited in claim 20, wherein the adhesion layer is a chromium based material.

27. (canceled)

28. (canceled)

29. The plasmonic nanostructure for enhanced light excitation, as recited in claim 20, wherein the adhesion layer is a titanium based material.

30. (canceled)

31. (canceled)

32. The plasmonic nanostructure for enhanced light excitation, as recited in claim 20, wherein the adhesion layer is indium tin oxide (ITO).

33. The plasmonic nanostructure for enhanced light excitation, as recited in claim 21, wherein the cover layer is a chromium based material.

34. (canceled)

35. (canceled)

36. The plasmonic nanostructure for enhanced light excitation, as recited in claim 21, wherein the cover layer is titanium dioxide (TiO₂).

37. The plasmonic nanostructure for enhanced light excitation, as recited in claim 21, wherein the cover layer is indium tin oxide (ITO).

38. The plasmonic nanostructure for enhanced light excitation, as recited in claim 21, wherein the adhesion layer is gold (Au).

39. A nanochannel for enhanced light excitation, comprising:
a substrate;
an adhesion layer disposed on top of the substrate;
a surface plasmon resonance layer disposed on top of the adhesion layer; and
a nanochannel defined across a top surface of the surface plasmon resonance layer, wherein the surface plasmon resonance layer is configured to concentrate an applied plasmon field to a bottom portion of the nanochannel.

40. The nanochannel for enhanced light excitation, as recited in claim 39, further including a cover layer disposed on a top surface of the surface plasmon resonance layer, wherein the cover layer is configured to disperse an applied plasmon field at a top portion of the nanochannel.

41. The nanochannel for enhanced light excitation, as recited in claim 40, wherein the plasmon field strength is greater at the bottom portion than at the top portion.

42. The nanochannel for enhanced light excitation, as recited in claim 40, wherein the nanochannel further extends through the surface plasmon resonance layer to a top surface of the adhesion layer.

43. The nanochannel for enhanced light excitation, as recited in claim 40, wherein the nanochannel further extends through the adhesion layer to a top surface of the substrate.

44. The nanochannel for enhanced light excitation, as recited in claim 39, wherein the surface plasmon resonance layer is a metal or metal alloy.

45. (canceled)

46. The nanochannel for enhanced light excitation, as recited in claim 39, wherein the adhesion layer is a chromium based material.

47. (canceled)

48. (canceled)

49. The nanochannel for enhanced light excitation, as recited in claim 39, wherein the adhesion layer is a titanium based material.

50. (canceled)

51. (canceled)

52. The nanochannel for enhanced light excitation, as recited in claim 39, wherein the adhesion layer is indium tin oxide (ITO).

53. The nanochannel for enhanced light excitation, as recited in claim 40, wherein the cover layer is a chromium based material.

54. (canceled)

55. (canceled)

56. The nanochannel for enhanced light excitation, as recited in claim 40, wherein the cover layer is titanium dioxide (TiO₂).

57. The nanochannel for enhanced light excitation, as recited in claim 40, wherein the cover layer is indium tin oxide (ITO).
